(19) United States
(12) Patent Application Publication
(10) Pub. No.: US 2016/0173741 A1
(43) Pub. Date: Jun. 16, 2016

(54) MOORING SYSTEM FOR UNDERWATER CAMERA

(71) Applicant: DANIEL WOLFENBARGER, Zolfo Springs, FL (US)

(72) Inventor: DANIEL WOLFENBARGER, Zolfo Springs, FL (US)

(21) Appl. No.: 14/967,325

(22) Filed: Dec. 13, 2015

Related U.S. Application Data
(60) Provisional application No. 62/092,529, filed on Dec. 16, 2014.

(51) Int. Cl. H04N 5/225; H04N 5/232; H04N 5/44

(52) U.S. Cl. CPC H04N 5/2252; H04N 5/44; H04N 5/23296; H04N 5/2257

(57) ABSTRACT

A device for viewing images from under a surface of a body of water includes a camera pod provided with a housing containing a pan-tilt-zoom underwater camera. A mooring is structure fixed to the camera pod for maintaining the camera pod at a substantially constant distance from a floor of the body of water. A tether that conducts control signals sent from a base station located above the surface of the body of water a to the pan-tilt-zoom underwater camera and image signals from the pan-tilt-zoom underwater camera to the base station.

This is a nonprovisional application claiming priority of provisional application Ser. No. 62/092,529 filed Dec. 16, 2014.

### FIELD OF THE INVENTION

The present invention relates to under water observation and, more particularly, to a mooring system for an underwater camera.

### BACKGROUND OF THE INVENTION

The problems that exist with all toss over the side cameras is the inability to adjust the viewing angle (up and down), and the difficulty in changing the direction the camera is facing. Until now this is typically done manually by twisting a tether that connects to the camera. However, this puts a strain on wire conductors in the tether. Also this type of camera system is susceptible to wave action, whether from head on or from the sides. The wave action causes the camera to move with the wave and loose the frame of what was being observed. The use of this style camera is very difficult to set up, operate and secure (from theft) if the unit is not supervised constantly. For a small underwater camera the same shortcomings exist There are no known commercially available solutions to these problems.

It would be advantageous to provide a stable system with expandable power capabilities to deploy and operate and underwater camera. It would also be advantageous to provide a multi directional camera for 360 degree around and 90 degree up/down viewing. It would further be advantageous to provide a secure locking system for theft prevention.

### SUMMARY OF THE INVENTION

In accordance with the present invention, there is provided a completely portable self-contained underwater observation system for long and short term operation.

### BRIEF DESCRIPTION OF THE DRAWINGS

FIGS. 1-1A show an underwater observation system available in the prior art as affected by wave motion.

FIG. 2 is a schematic comparison of the field of view of the prior art observation system of FIGS. 1 and 2 versus the field of view obtainable with a camera deployed using a mooring system for an underwater camera according to the present invention.

FIG. 2A is another schematic comparison of the field of view of the prior art observation system of FIGS. 1 and 2 versus the field of view obtainable with a camera deployed using a mooring system for an underwater camera according to the present invention.

FIGS. 3-3C show an exemplary base station power supply for use with a mooring system for an underwater camera according to the present invention.

FIGS. 4-4A illustrate the use of the exemplary base station power supply for controlling the deployment of a mooring system for an underwater camera according to the present invention.

FIGS. 5-5A show a mooring system for an underwater camera according to the present invention as being unaffected by wave motion.

FIG. 6 show an a mooring system for an underwater camera according to the present invention used in calm water.

FIG. 6A shows an underwater camera deployed without the new mooring system.

FIG. 7 shows an underwater camera deployed from a structure built out from the land over water but without the new mooring system.

FIG. 8 shows an exemplary mooring system for an underwater camera according to the present invention deployed from a structure built out from the land over water.

FIG. 9 shows a first embodiment of an exemplary mooring system for an underwater camera according to the present invention located on a structure built out from the land over water with a remotely located controller.

FIGS. 10-13 show a first embodiment of an exemplary mooring system for an underwater camera according to the present invention mounted to a structure built out from the land over water.

FIGS. 14-15 show a third embodiment of an exemplary mooring system for an underwater camera according to the present invention deployed using a buoy.

FIGS. 16A-17A are pictorial representations of a second embodiment of an exemplary mooring system with an underwater camera according to the present invention.

FIG. 18 is a section view of the second embodiment of an exemplary mooring system with an underwater camera taken at line 18-18 of FIG. 16A.

FIG. 19 is a front elevation view of the second embodiment of an exemplary mooring system with an underwater camera.

FIG. 20 is a side elevation view of the second embodiment of an exemplary mooring system with an underwater camera.

FIG. 21 is an exploded view of a camera pod used with the first, second and third embodiments of the exemplary mooring systems with an underwater camera.

FIG. 22 is an exploded view of a mooring subassembly of the second embodiment of an exemplary mooring system with an underwater camera.

FIG. 23 is a pictorial view of a system used in the first embodiment for mounting the mooring system to a structure built out from the land over water.

FIG. 24 is a schematic side elevation view of a system used in the first embodiment for mounting the mooring system to a structure built out from the land over water.

FIG. 25 is a schematic front elevation view of a system used in the first embodiment for mounting the mooring system to a structure built out from the land over water.

FIG. 26 is a schematic exploded view of the system used in the first embodiment for mounting the mooring system to a structure built out from the land over water.

FIGS. 27-30A show an exemplary clamping device with a security feature for use with the system used in the first embodiment for mounting the mooring system to a structure built out from the land over water.

FIGS. 31-32 are exploded views of the exemplary clamping device with a security feature showing the clamp closed and open used in the first embodiment used in the first embodiment.

FIGS. 33-36 are a pictorial views of an exemplary buoy that can be used with the third embodiment for deploying a mooring system with an underwater camera.

FIG. 37 is a section view of the exemplary buoy taken at line 37-37 of FIG. 33

FIG. 38 is an exploded view of an upper subassembly of the exemplary buoy.

FIG. 39 is an exploded view of a lower subassembly of the exemplary buoy.

### DETAILED DESCRIPTION OF THE INVENTION

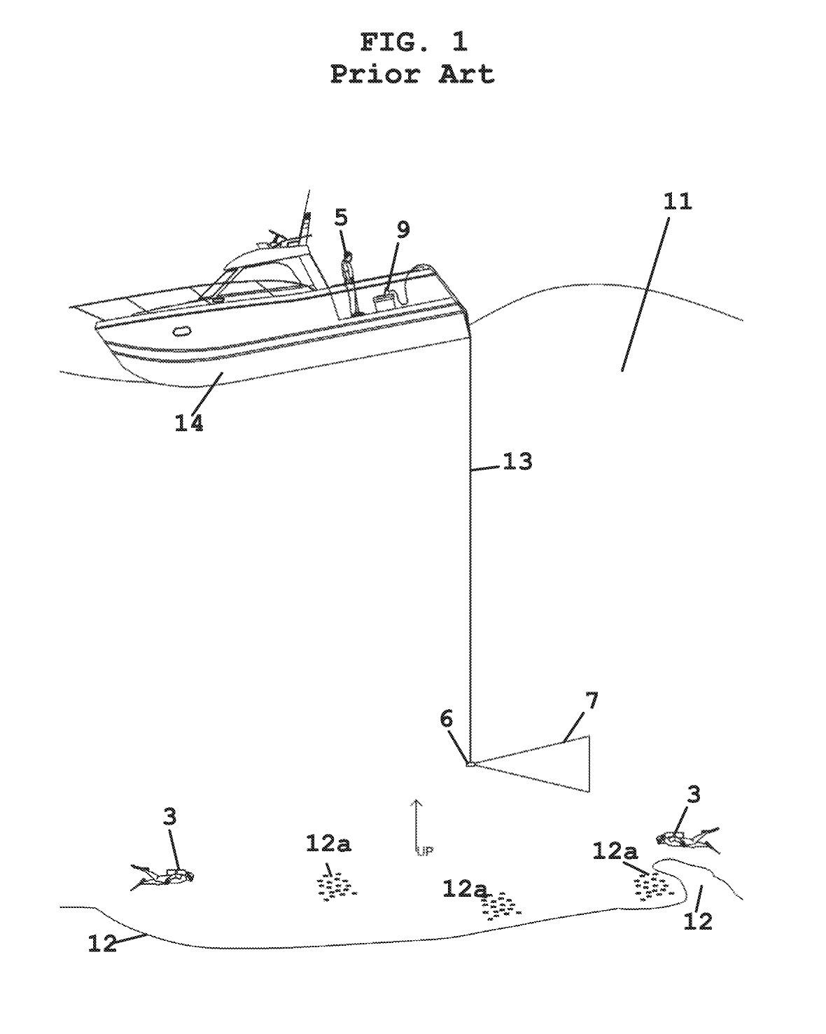

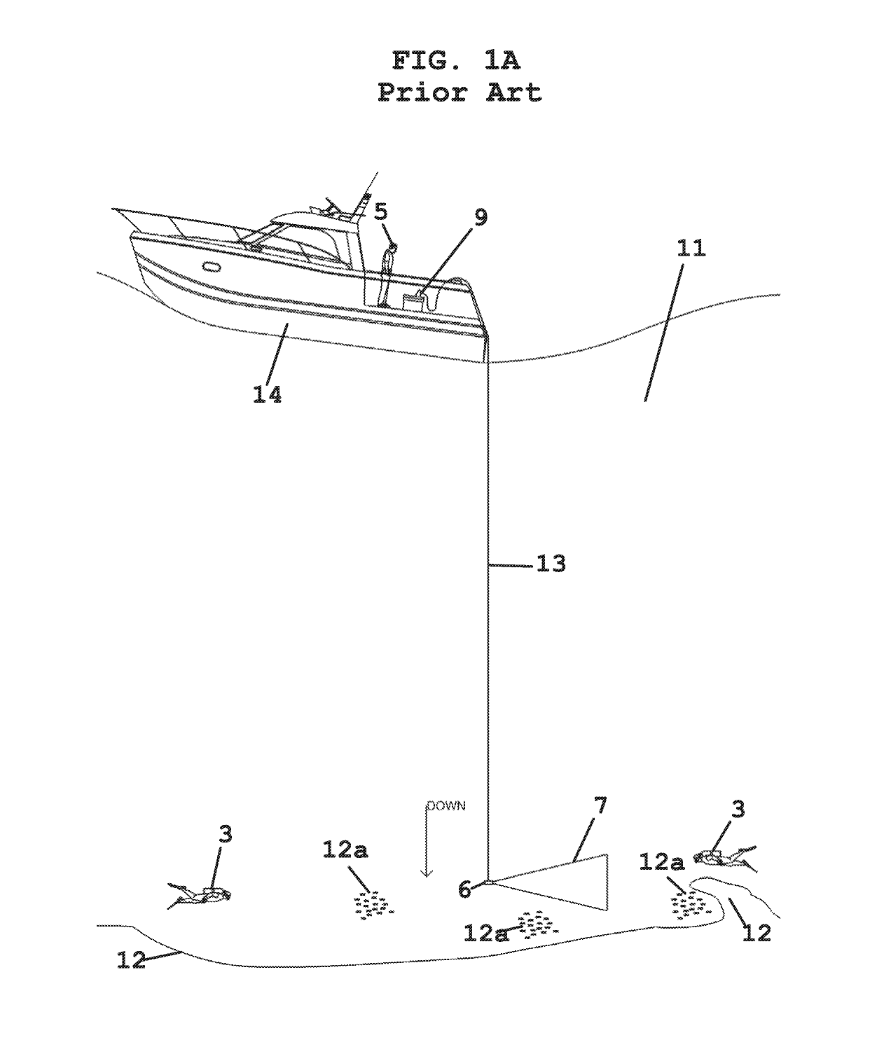

FIG. 1 shows a prior art underwater observation system deployed from a vessel 14 into a body of water 11 at a crest of a wave. A person 5 on the vessel observes a monitor 9 that displays an image retrieved by an underwater camera 6 via a tether 13. A field of vision viewed using the underwater camera is represented by a cone 7. The underwater camera is shown suspended in the water at a distance from the floor 12 of the body of water 11. Examples of typical objects that may be seen in the water are fish 12a and divers 3 This drawing shows the relative position of the underwater camera as the surface vessel 14 rides over a crest of a wave the underwater camera is pulled up away from the objects to be observed.

FIG. 1A show the same underwater observation system as shown in FIG. 1 as affected by wave motion when the vessel 14 is in a trough of a wave. The typical over the side underwater camera 6 descends suddenly causing the distance from the floor 12 of the body of water 11 to be less than shown in FIG. 1. The field of vision 7 viewed by the person 5 using the monitor 9 via the tether 13 is displaced from that shown in FIG. 1. Using the underwater camera in a conventional prior art manner in rough or even slightly wavy seas results in images very hard to watch because the field of view is always changing unless the body of water is at a dead calm.

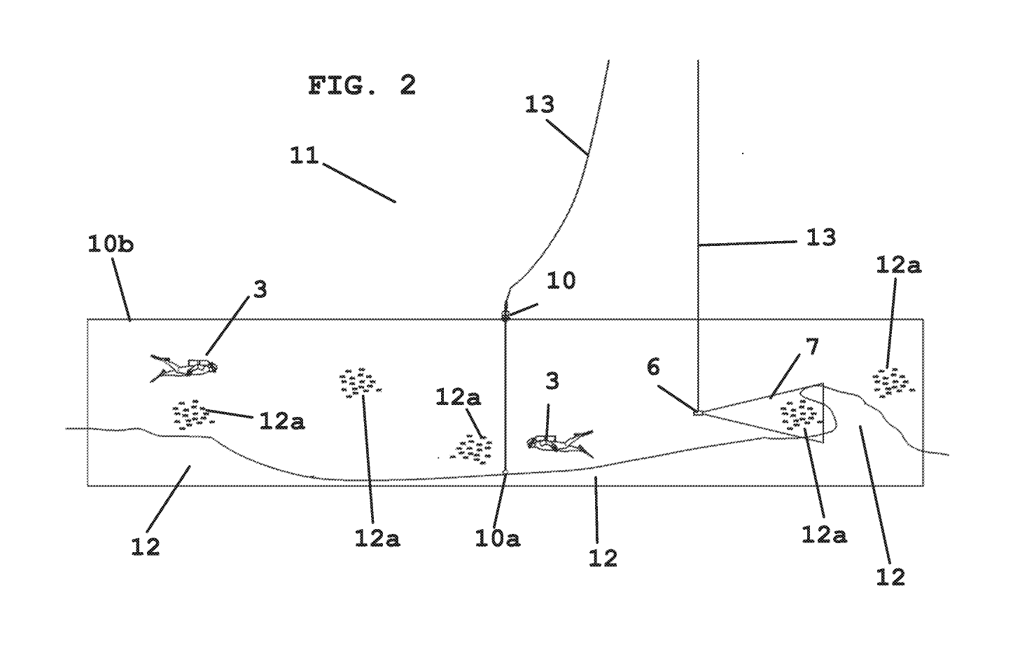

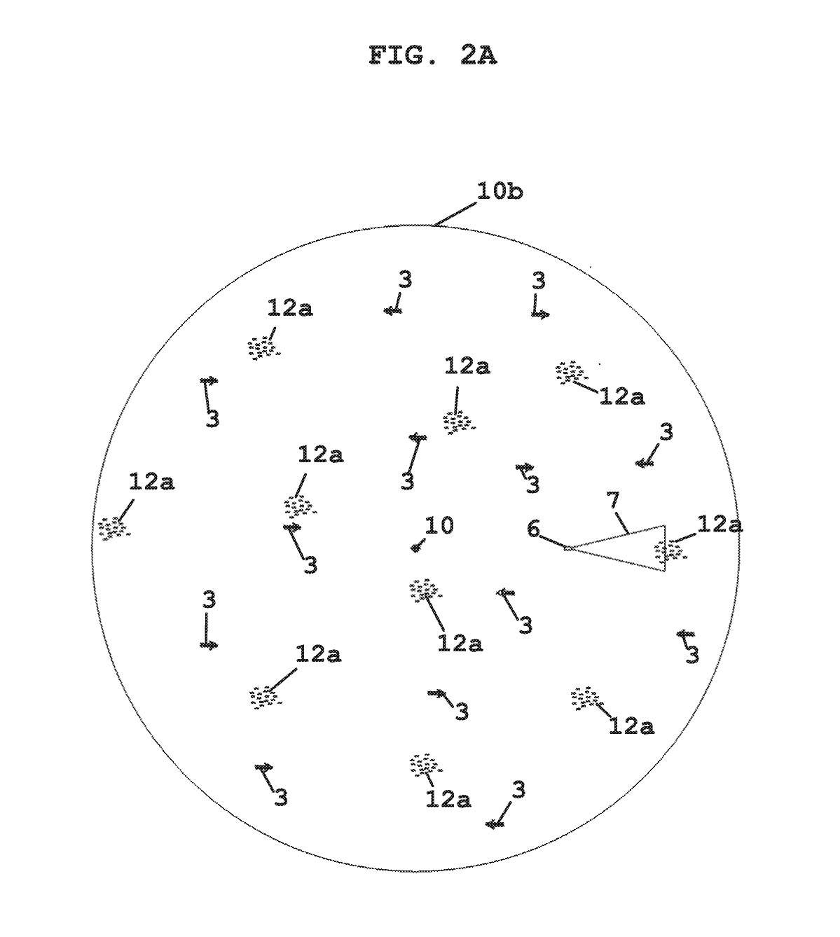

FIG. 2 is a schematic comparison of the field of view 7 of the prior art observation system of FIGS. 1 and 2 with a conventional over the side underwater camera 6 versus the 360 degree field of view 10b obtainable with an pan-tilt-zoom underwater camera pod 10 deployed using a mooring system 10a for an underwater camera according to the present invention. As used herein and in the claims the term “camera pod” is understood to refer to a housing containing a camera. Both cameras communicate with out of water monitors via tethers 13. FIG. 2A is another schematic comparison, this time a top view looking downward, of the field of view 7 of the prior art observation system of FIGS. 1 and 2 versus the field of view 10b obtainable with a pan-tilt-zoom underwater camera deployed using a mooring system for an underwater camera according to the present invention. Again in FIGS. 2-2A examples of objects viewable in the body of water 11 are fish 12a and divers 3.

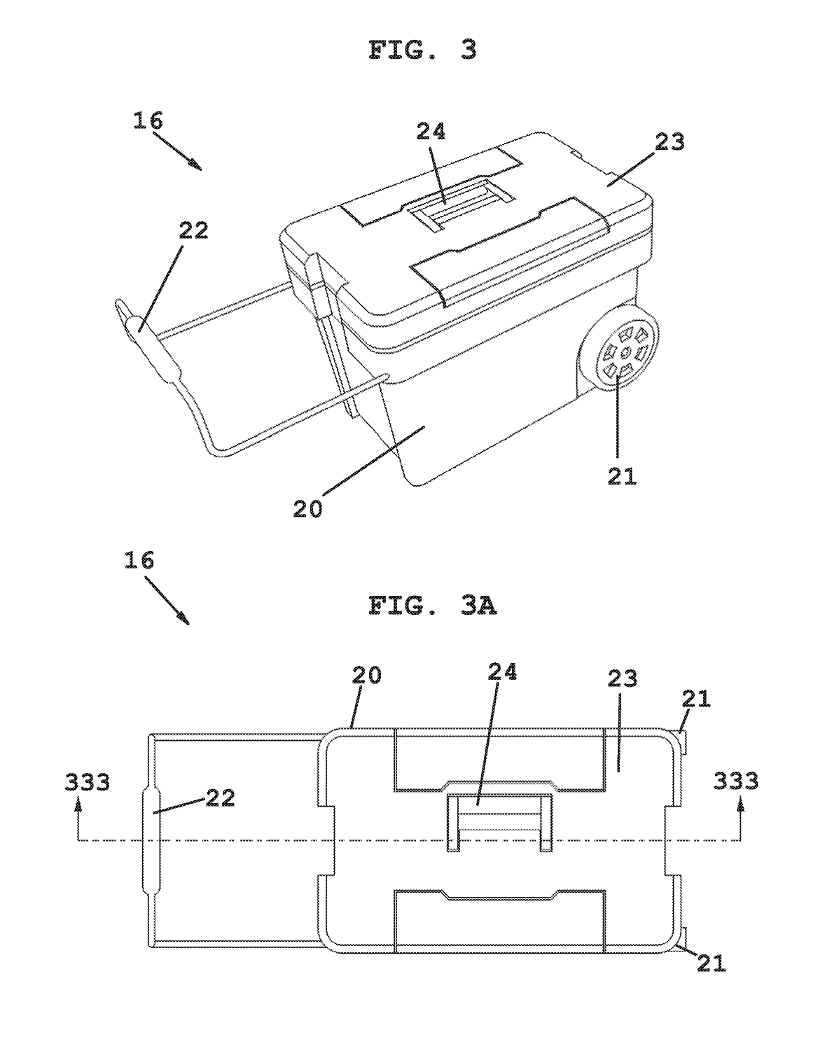

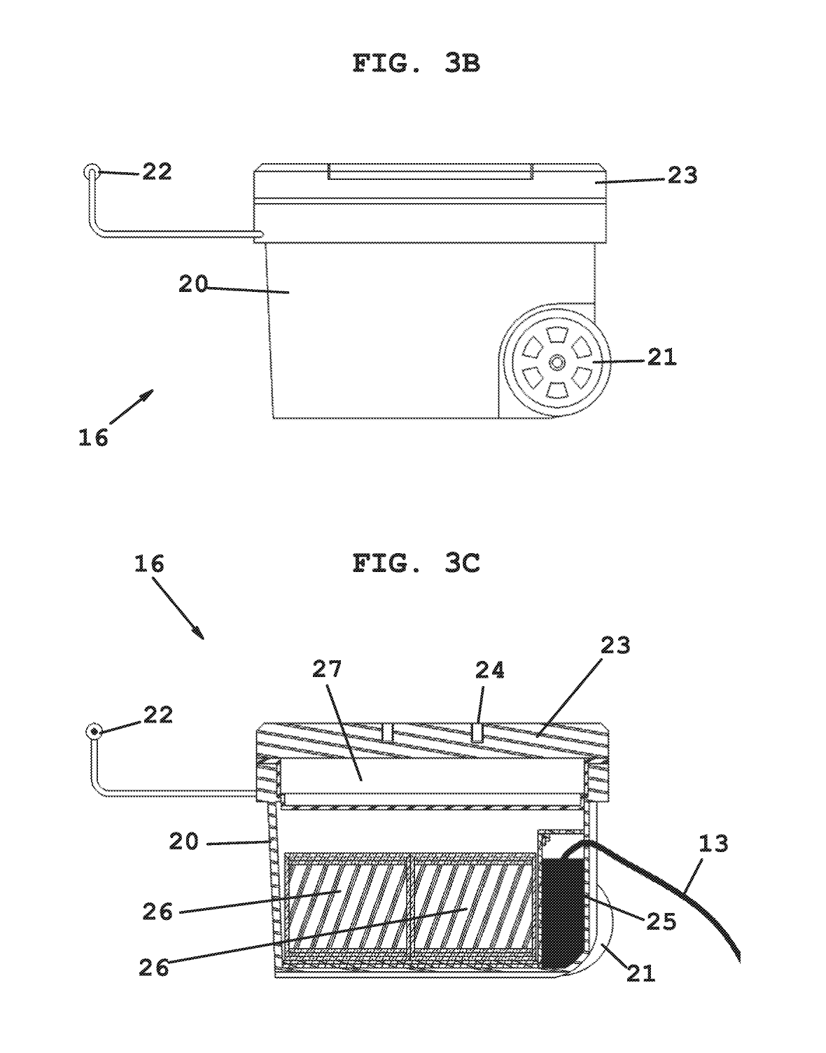

FIGS. 3-3C show an exemplary base station power supply disclosed in my copending U.S. patent application Ser. No. 14/569,744 filed Dec. 14, 2014 for use with a mooring system for an underwater camera according to the present invention. FIG. 3 is a perspective view of an exemplary portable base station 16 that is a combination power and communication relay station for use with a mooring system for an underwater camera according to the present invention. FIG. 3A is a top view of the exemplary portable base station 16. FIG. 3B is a side view of the exemplary portable base station 16. FIG. 3C is a section view, taken at line 333-333 of FIG. 3A, of the exemplary portable base station 16.

The portable base station 16 includes a container 20 provided with wheels 21 and a handle 22 for pushing or pulling the base station to facilitate moving the base station as desired. The container 20 may be made of any suitable material such as a metal or plastic. It is understood that while the base station is shown as being portable in FIGS. 3-3C, that the wheels 21 and handle 22 may be omitted if a person setting up a system to use a mooring system with an underwater camera elects to have the base station installed permanently in a selected location. Whether portable or stationary a base station may be provided with at least one forty eight volt battery pack 26 and an electronics package 25. For example each power pack 26 may comprise four twelve volt batteries. The at least one battery pack may be replaced or supplemented by a forty eight volt DC converter pack for use in locations where one hundred ten volt AC power is available. The electronics package 25 communicates with a mooring system with an underwater camera either directly via a tether 13 or indirectly via an intermediary relay station, such as a buoy, to be described in more detail below with regards to FIGS. 14-15 and 33-37. In the illustrated exemplary base station the tether 13 may be either permanently wired to the electronics package or may be attached in a removable manner using appropriate male and female connectors.

A top cover 23 of the exemplary base station may be lifted or pivoted about a hinge using a handle 24 to provide access to a storage compartment 27 for storing a laptop computer, spare parts and other articles relating to the use of the base station. It is understood that if the base station is connected to a power grid the current may be converted to an appropriate voltage and amperage to operate the system components that would otherwise be powered by the battery pack and that in such a configuration the power pack can be configured to provide backup power in the event of a loss of electric service from the power grid.

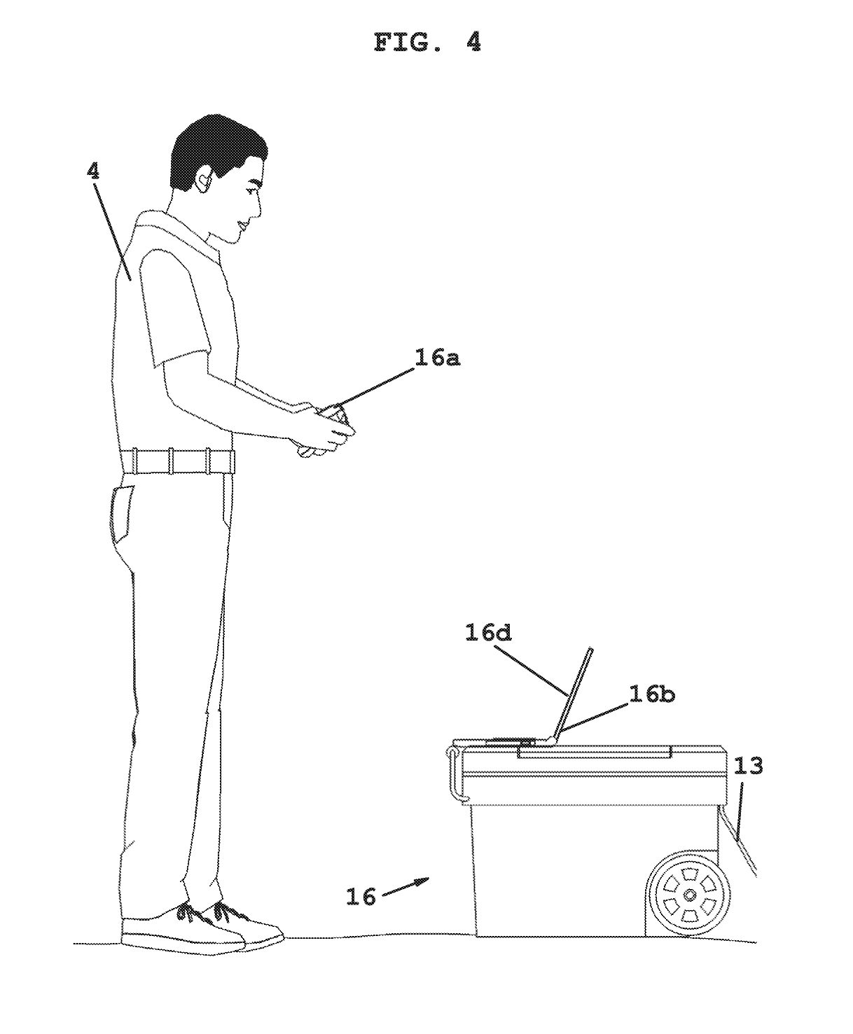

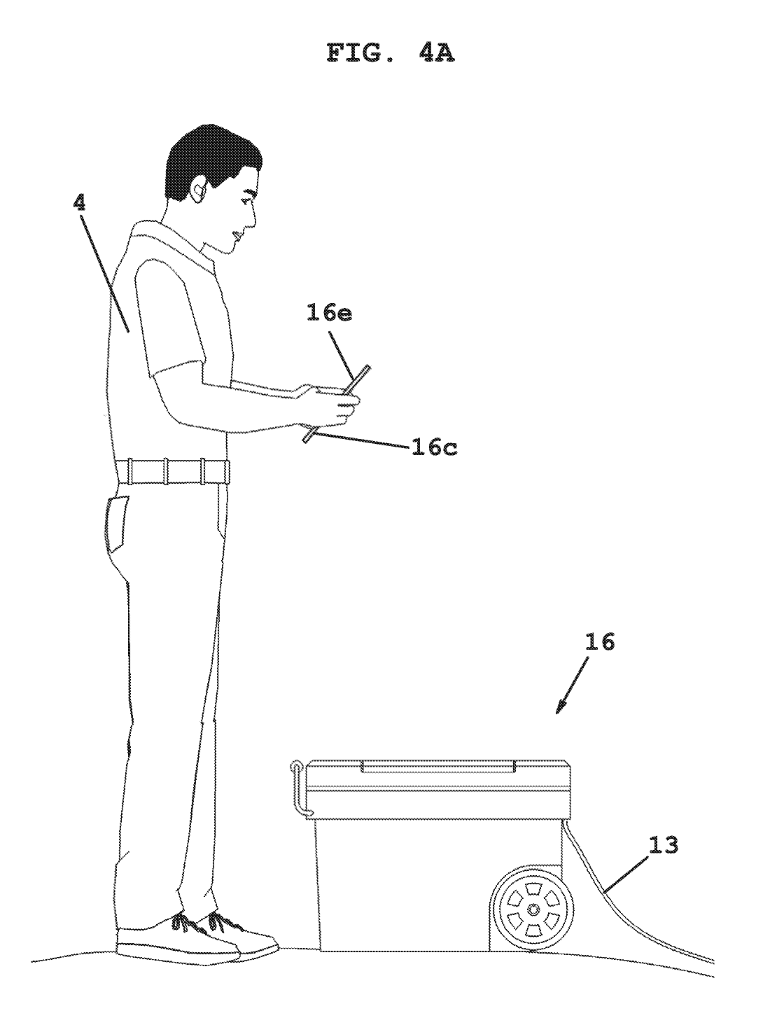

In a manner similar to what I have disclosed in my copending U.S. patent application Ser. No. 14/569,744 filed Dec. 14, 2014 FIGS. 4-4A illustrate the use of the exemplary base station power supply 16 for controlling the deployment of a mooring system for an underwater camera according to the present invention. As shown in 3-3C the base station 16 is shown as being a portable device. In FIG. 4 a land based person 4 uses a controller 16a (Joystick, Joypad, Keyboard, Flightstick) in conjunction with a laptop PC 16b and appropriate software to send and receive control signals, data, video and sound information between the base station 16 and a mooring system to an underwater camera. Images retrieved by an underwater camera and transmitted to the laptop 16b can be viewed by the person 4 on a monitor screen 16d of the laptop. In FIG. 4A a land based person 4 uses a using a Tablet PC 16c or Smartphone to view Images retrieved by an underwater camera and transmitted to the Tablet PC 16c can be viewed by the person 4 on a monitor screen 16e of the Tablet PC.

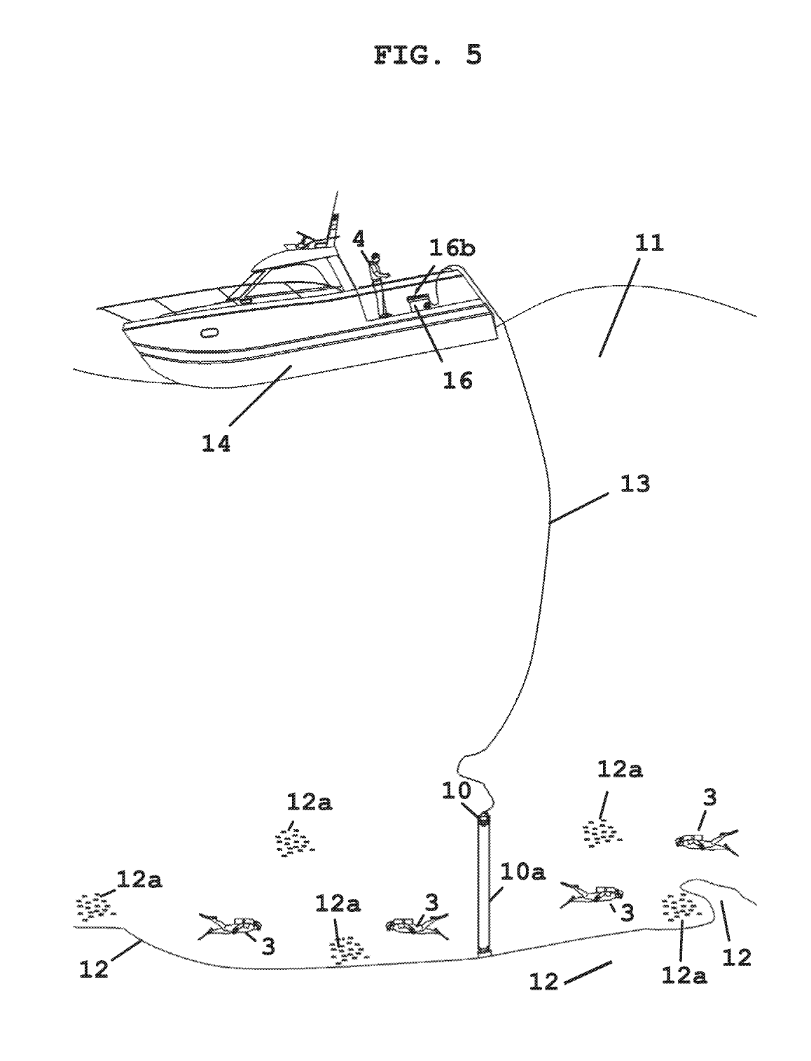

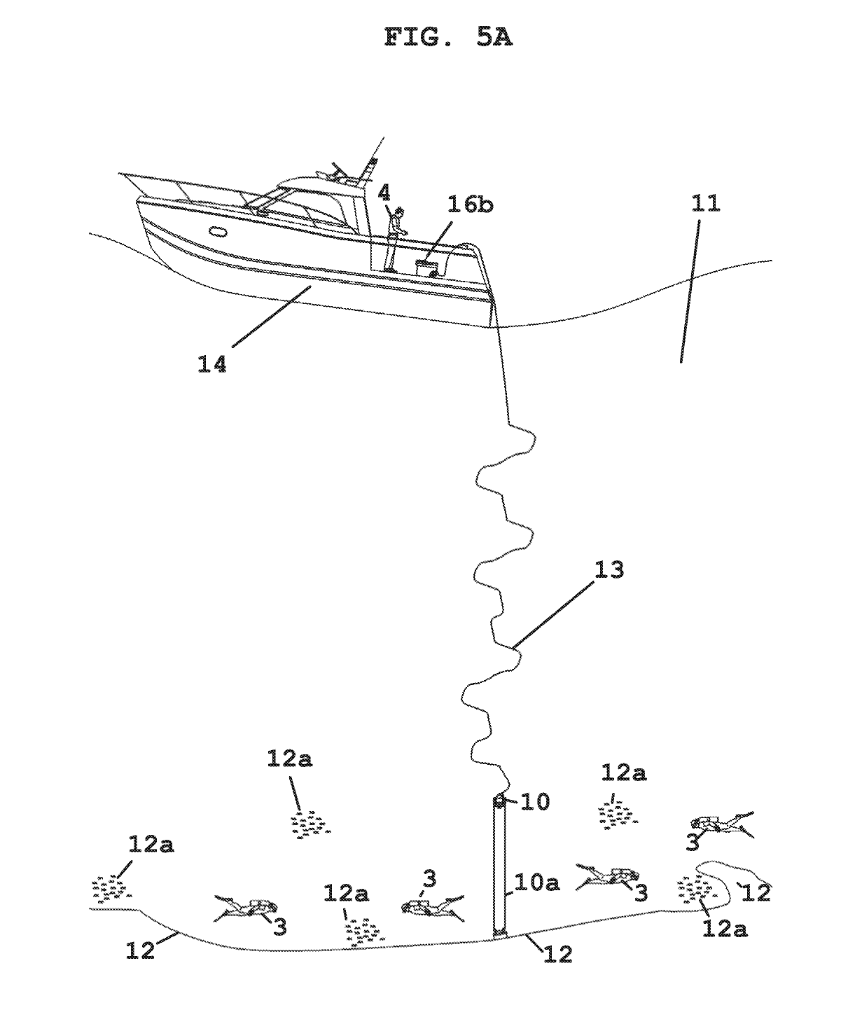

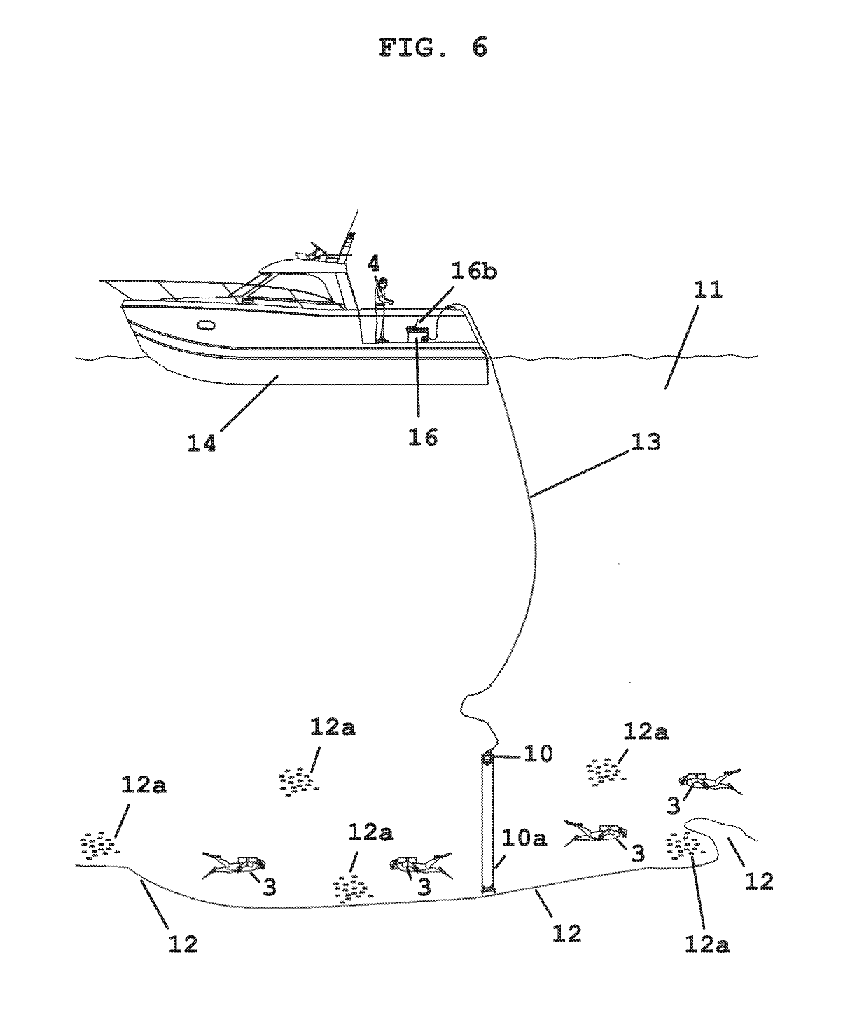

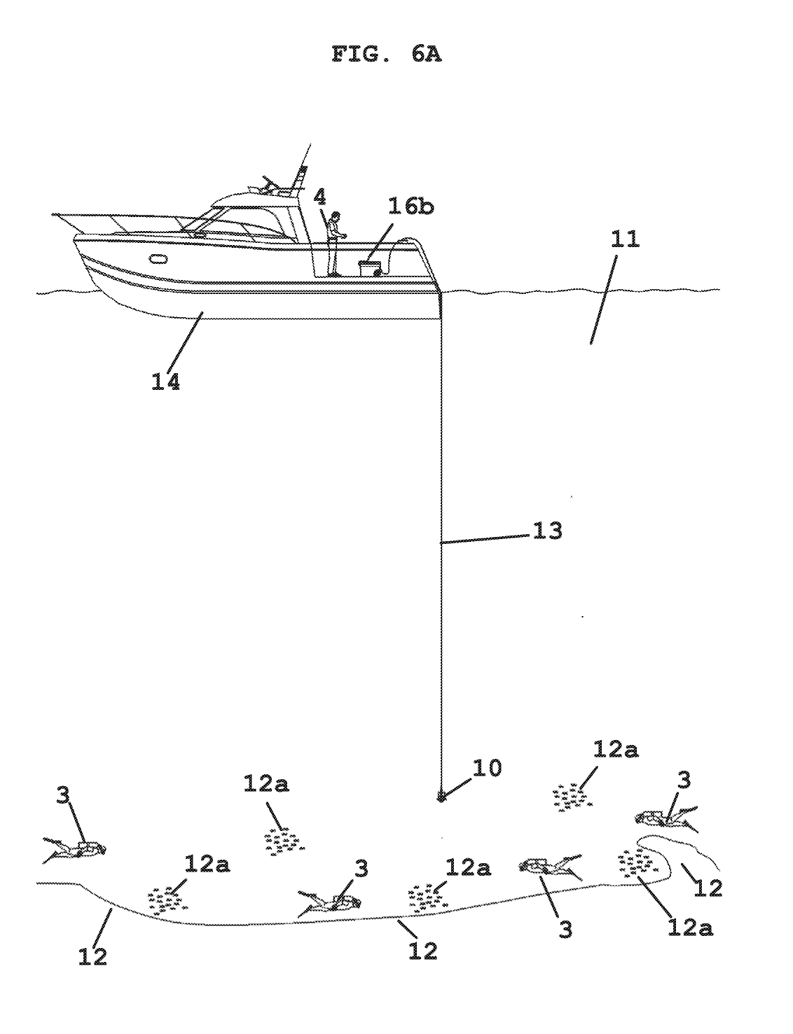

FIGS. 5-5A show a mooring system 10, 10a, 13 for an underwater camera according to the present invention as being unaffected by wave motion. In contrast, as described above with respect to FIGS. 1-1A a prior art underwater observation system is susceptible to an over the side underwater camera repeatedly bobbing up and down in even small waves. FIG. 5 shows a surface vessel 14 riding a wave crest in a body of water 11 and FIG. 5A shows the same surface vessel 14 descending into a wave trough while a mooring system 10, 10a, 13 for an underwater camera of the present invention maintains a substantially constant distance between the underwater camera pod 10 and the floor 12 of the body of water even in rough seas. FIG. 6 shows the same surface vessel 14 with the same mooring system 10, 10a, 13 for an underwater camera according to the present invention in calm waters. (Note that even in calm waters the tether 13 has some slack to compensate for minor drifting of the surface vessel 14.) Details of the structure and function of the mooring system 10, 10a, 13 for an underwater camera are described below. A person 4 on the vessel 14 is able to view on a monitor screen stable images retrieved by the underwater camera pod 10 and transmitted to a laptop 16b which rests on a portable base station 16. Again in FIGS. 5-5A examples of objects viewable in the body of water 11 are fish 12a and divers 3.

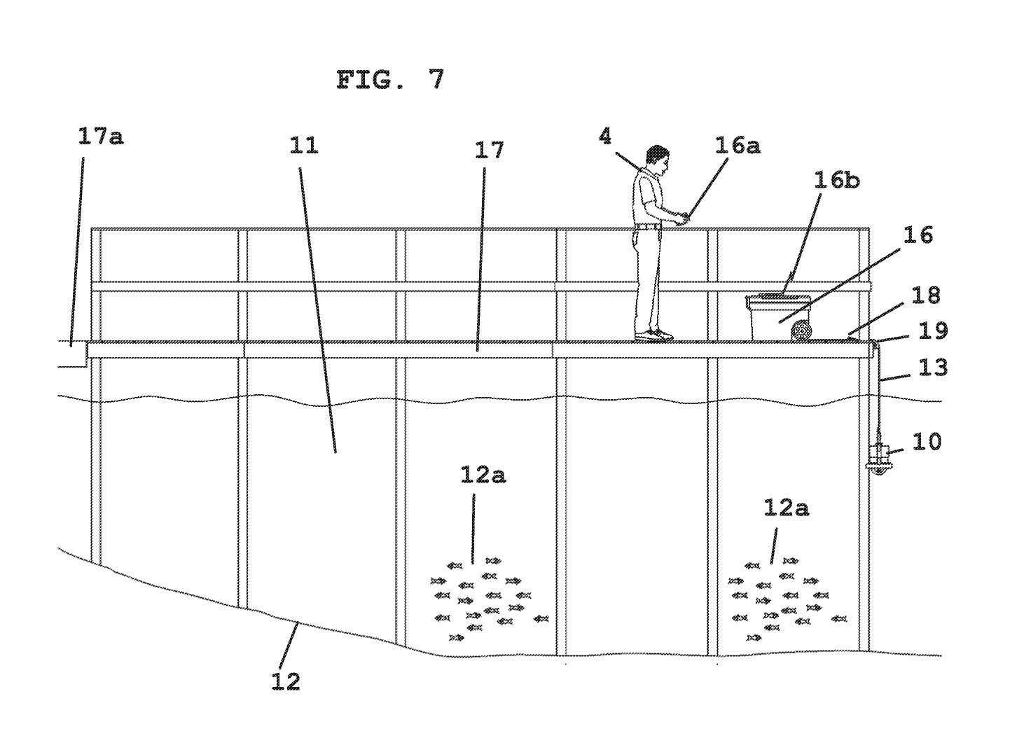

FIG. 6A shows a pan-tilt-zoom underwater camera pod 10 of the type employed in a mooring system for an underwater camera deployed without the mooring system in calm water to illustrate that a pan-tilt-zoom underwater camera pod 10 may be used in calm water like a conventional over the side camera. FIG. 7 shows a pan-tilt-zoom underwater camera pod 10 deployed from a structure 17 built out from the land 17a over water but without the new mooring system. A person 4 on the vessel 14 or structure 17 is able to view on a monitor screen stable images retrieved by the a pan-tilt-zoom underwater camera pod 10 and transmitted to a laptop 16b which rests on a portable base station 16 so long as the body of water 11 is relatively calm. Again in FIGS. 6A and 7 examples of objects viewable in the body of water 11 are fish 12a and divers 3. However once rough seas are encountered the same problems as conventional observation systems described above with respect to FIGS. 1-1A will be encountered with the distance from the over the side camera to the floor 12 of the body of water changing substantially constantly.

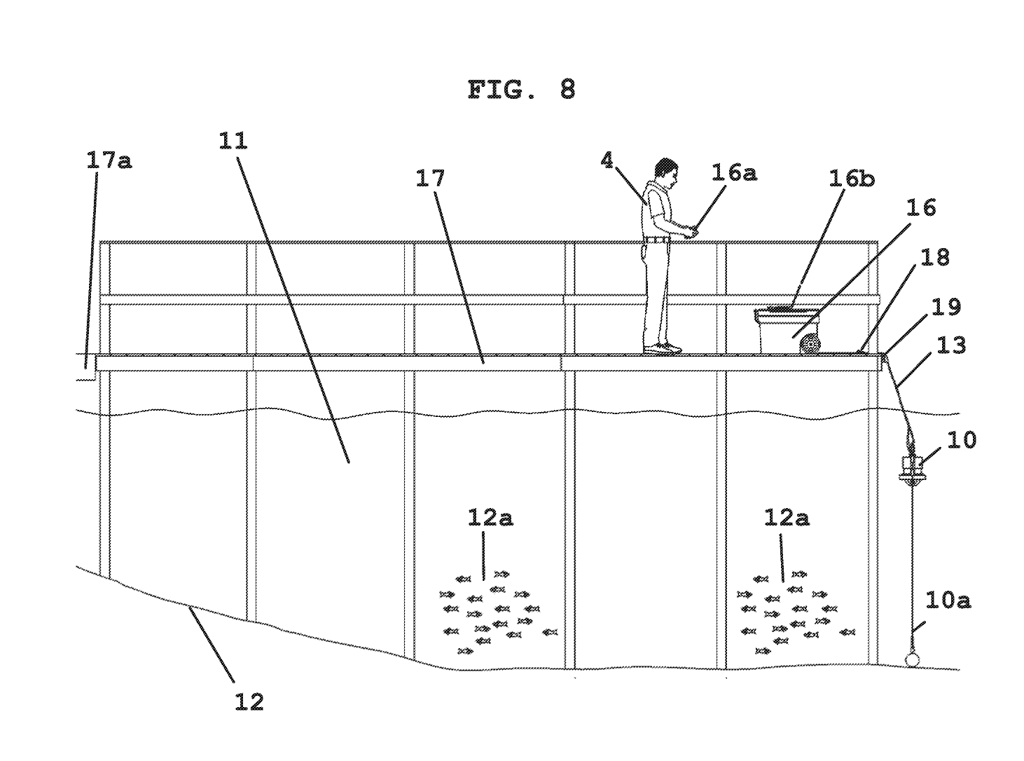

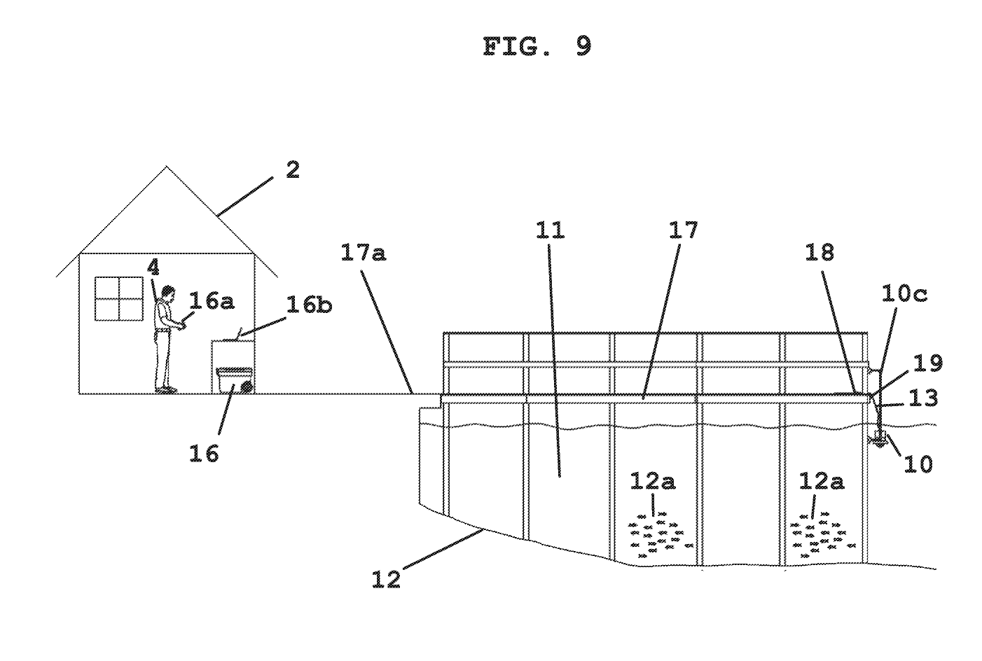

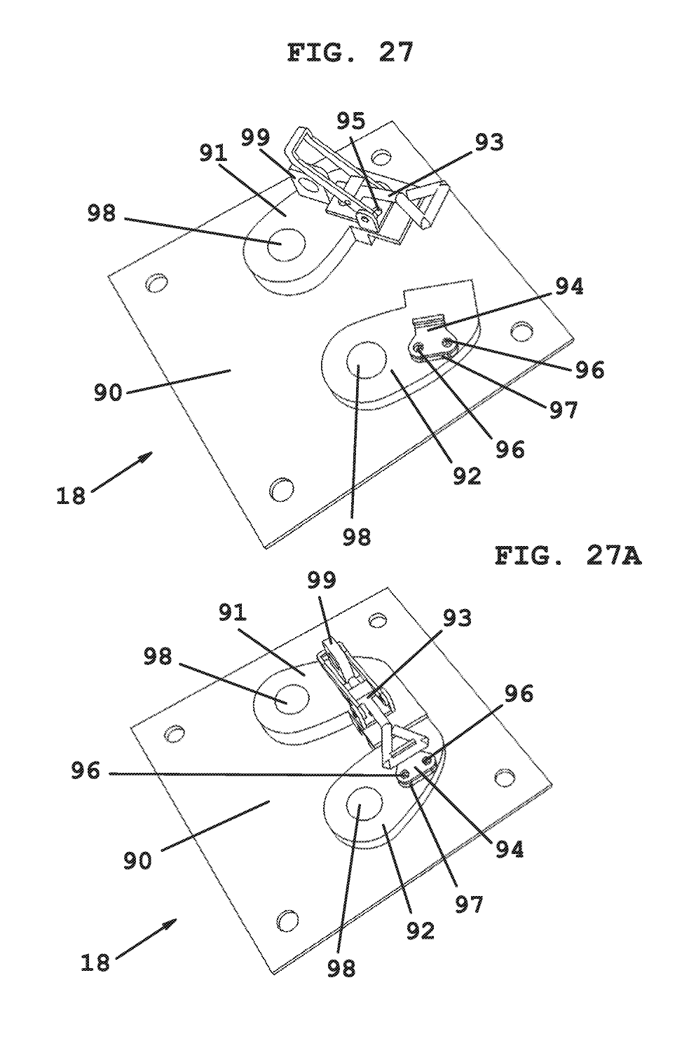

FIG. 8 shows an exemplary mooring system for an underwater camera pod 10. The camera pod is deployed from a structure 17 built out from the land 17a over water 11. A person 4 on the structure 17 is able to view on a monitor screen stable images retrieved by the a pan-tilt-zoom underwater camera pod 10 and transmitted to a laptop 16b which rests on a portable base station 16. The mooring structure 10a retains the pan-tilt-zoom underwater camera pod 10 at a substantially constant distance from the floor 12 of the body of water 11 in a manner that will be described in more detail below. A tether guide 19 helps to reduce damage and movement of the tether with respect to an edge of the structure 17. As shown a tether clamping device 18 secures the tether from unwanted tampering and is described in detail below with respect to FIGS. 27-30A. Again in FIG. 8 examples of objects viewable in the body of water 11 are fish 12a and divers 3. An advantage of the arrangement in FIG. 8 is portability of the exemplary mooring system for an underwater camera, but more permanent installations are described below with respect to FIGS. 9-13.

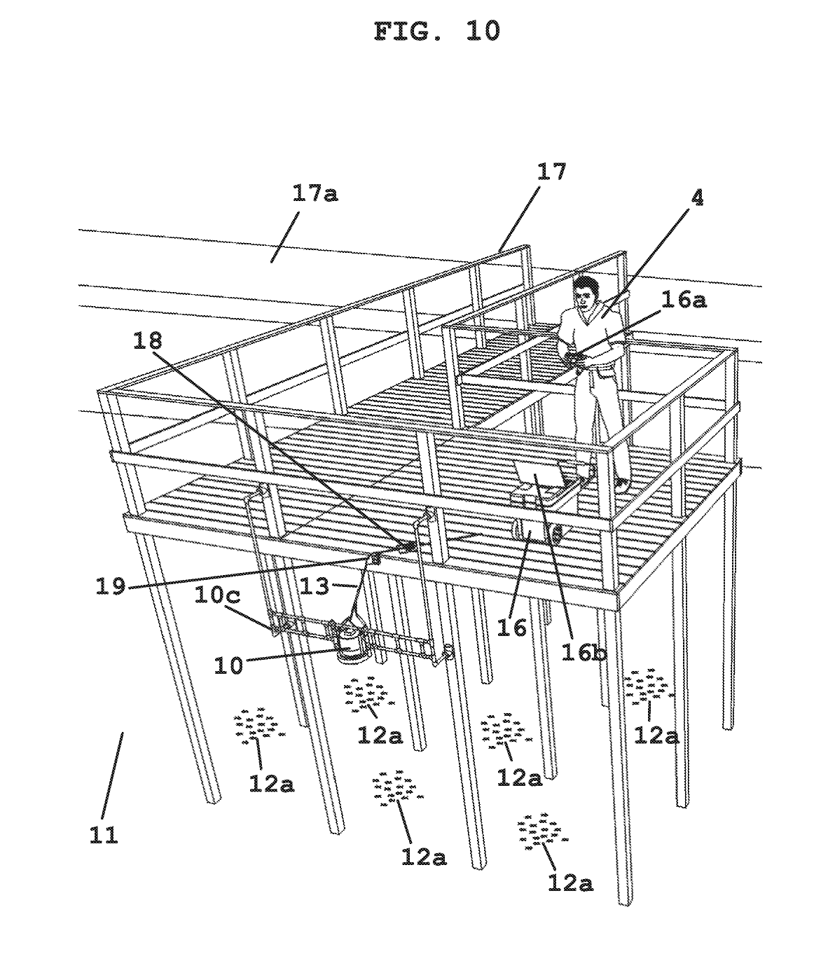

FIGS. 9-13, and 23-32 relate to a first embodiment of an exemplary mooring system for an underwater camera according to the present invention mounted to a structure built out from the land over water. FIG. 9 shows an exemplary mooring system for an underwater camera according to the present invention located on a structure built out from the land over water with a person 4 in or near a land based structure 2 using a remotely located display and controller. The remotely located controller has a laptop 16b associated with a portable base station 16. The land based person 4 uses a controller 16a (Joystick, Joypad, Keyboard, Flightstick) in conjunction with a Laptop PC 16b and appropriate software to send and receive control signals, data, video and sound information between the base station 16 and a mooring system for an underwater camera either wirelessly or via the tether 13 that runs along a top surface of the structure 17. A mooring assembly 10c is fixed to the stationery structure 17 built out from the land over water. The structure and function of the mooring assembly 10c is explained in detail below with regards to FIGS. 10-13, and 23-32.

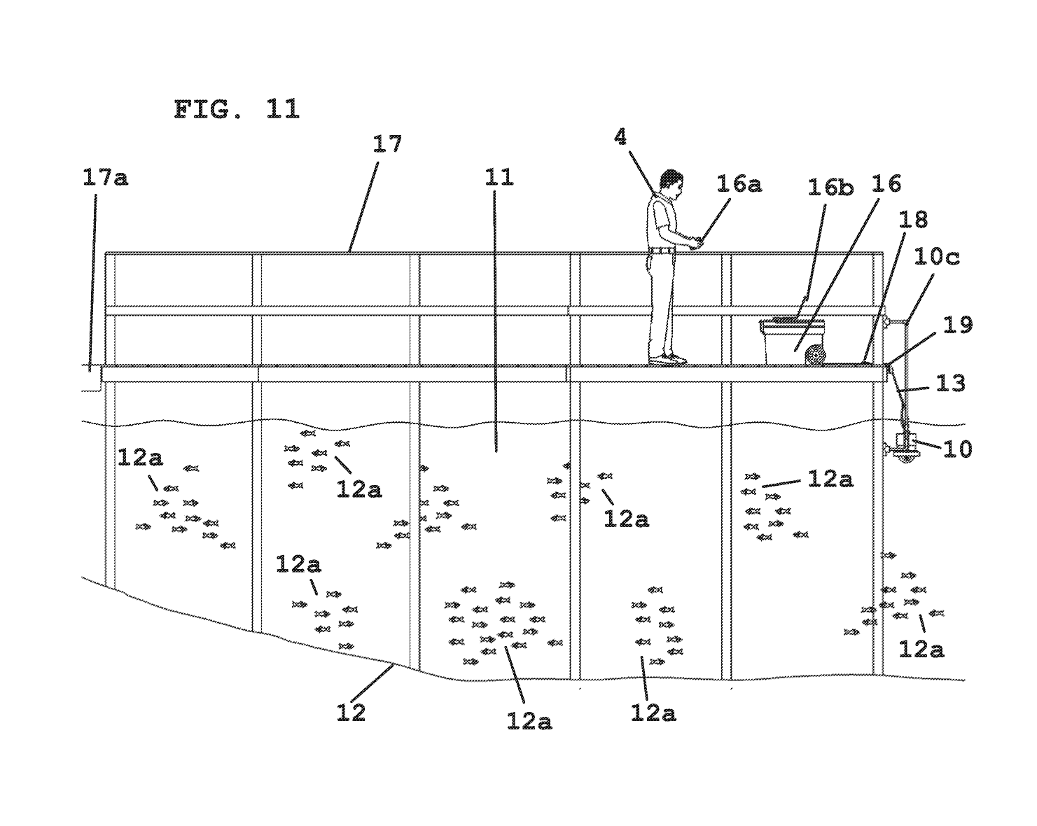

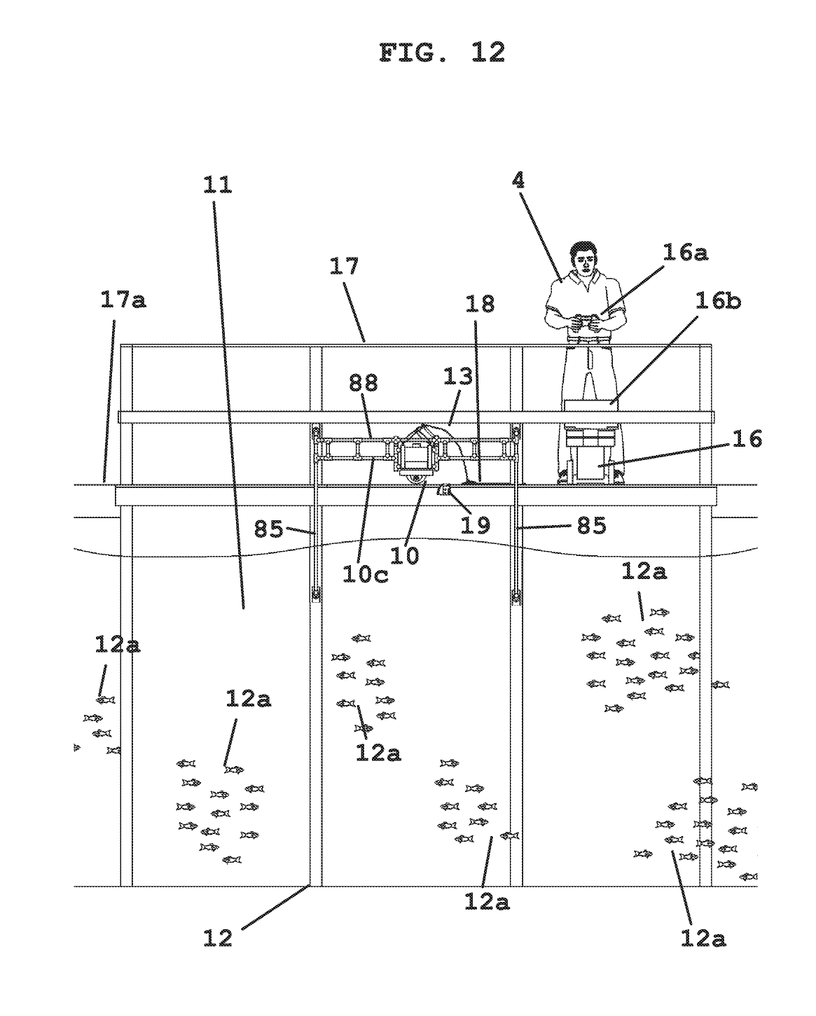

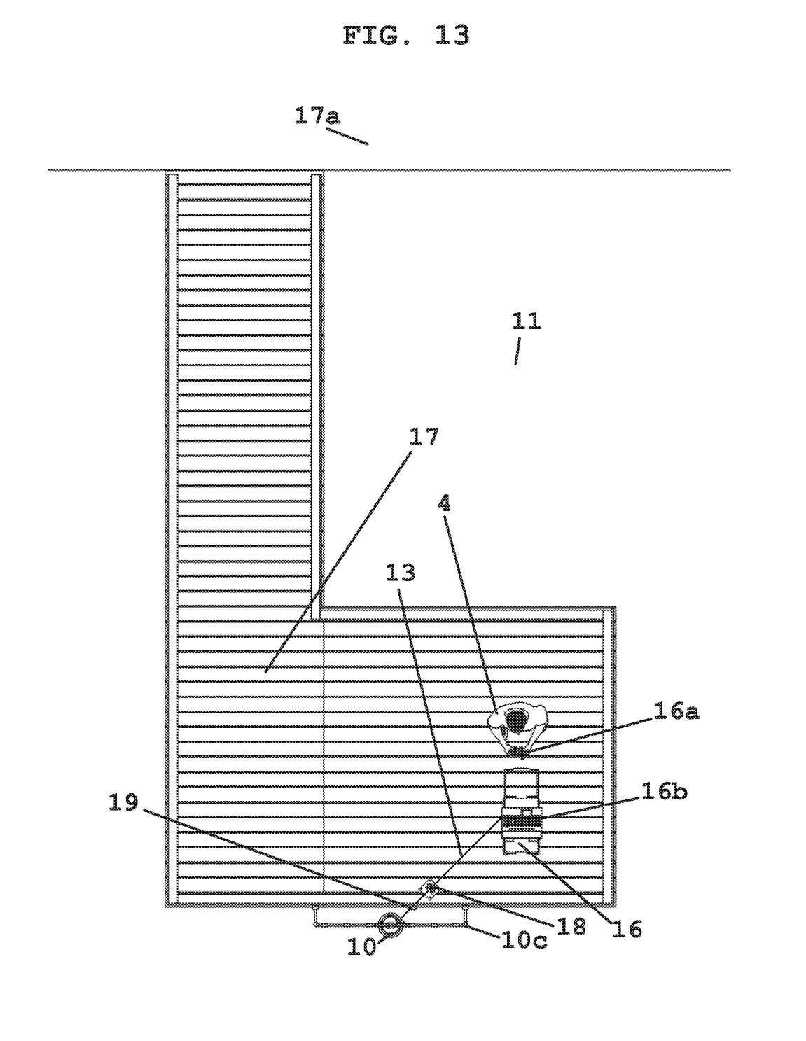

FIG. 10 is a perspective view of a typical installation of the first embodiment of an exemplary mooring system for an underwater camera mounted on a structure 17 built out from the land over water with the mooring assembly 10c slid downwardly to its greatest extent and the pan-tilt-zoom underwater camera pod subassembly 10 in the water. FIG. 11 is a left elevation view of a typical installation of the first embodiment of an exemplary mooring system for an underwater camera mounted on a structure 17 built out from the land over water with the mooring assembly 10c slid downwardly to its greatest extent and the pan-tilt-zoom underwater camera pod subassembly 10 in the water. FIG. 12 is a front elevation view of a typical installation of the first embodiment of an exemplary mooring system for an underwater camera mounted on a structure 17 built out from the land over water with the mooring assembly 10c slid upwardly and the pan-tilt-zoom underwater camera pod subassembly 10 out of the water. FIG. 13 is a top elevation view of a typical installation of the first embodiment of an exemplary mooring system for an underwater camera mounted on a structure 17 built out from the land over water. In this first embodiment a pan-tilt-zoom underwater camera pod subassembly 10, the structure and function of which are described in detail below with respect to FIGS. 16A-6B and 21, is fixed in a removable manner to the mooring assembly 10c. The mooring assembly 10c is fixed to the structure 17 using a fastening system such as bolts or clamps compatible with the design and material of the structure 17 and selected in accordance with good engineering practice. A tether guide 19 is fixed to the structure 17 and helps to reduce damage and movement of the tether 13 with respect to an edge of the structure. As shown a tether clamping device 18 is fixed to the structure and secures the tether 13 from unwanted tampering and is described in detail below with respect to FIGS. 27-30A. A person 4 on the structure 17 is able to view on a monitor screen stable images retrieved by the a pan-tilt-zoom underwater camera pod 10 and transmitted via conductors in the tether 13 to a laptop 16b which rests on a portable base station 16. Alternatively, the tether may conduct image signals to, and control signals from, an antenna (not shown) that communicates wirelessly with a controller 16a (Joystick, Joypad, Keyboard, Flightstick) in conjunction with a Laptop PC 16b. Again examples of objects viewable in the body of water 11 are fish 12a.

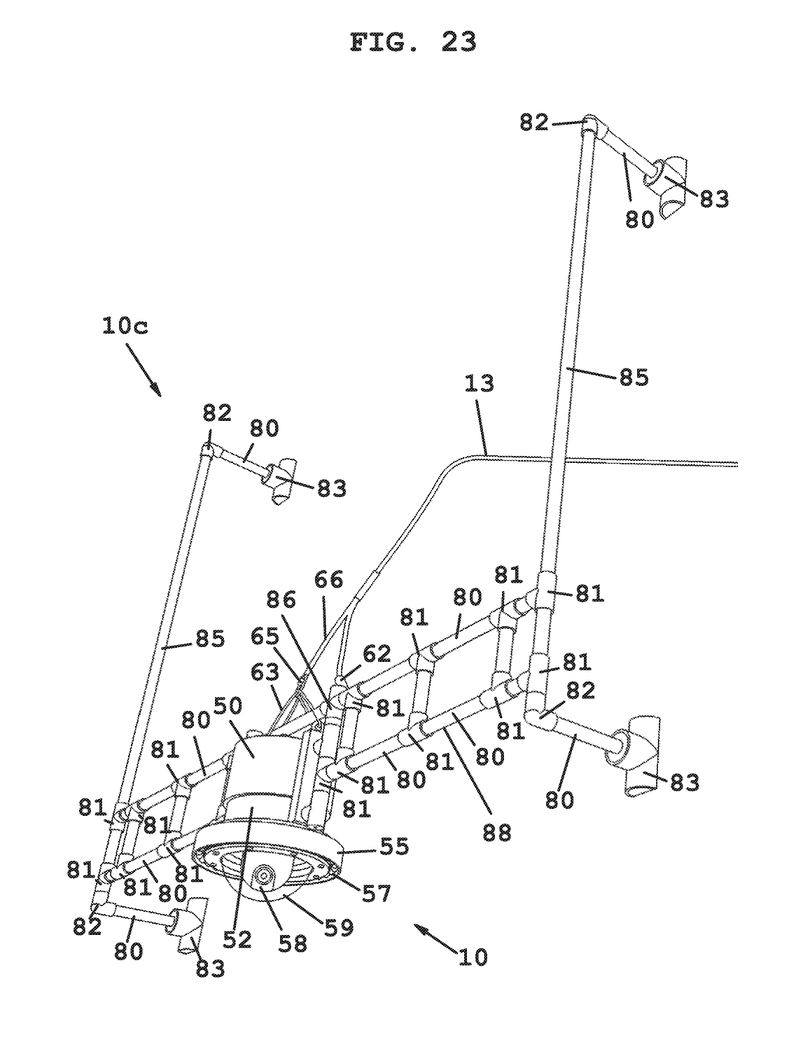

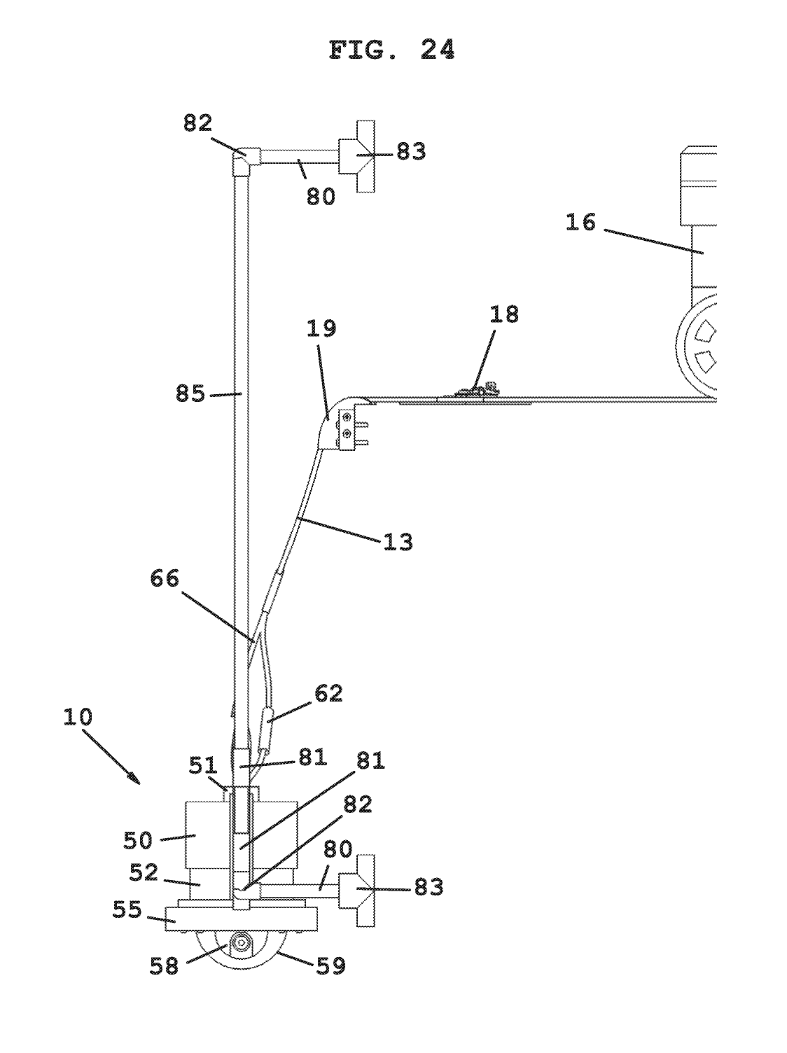

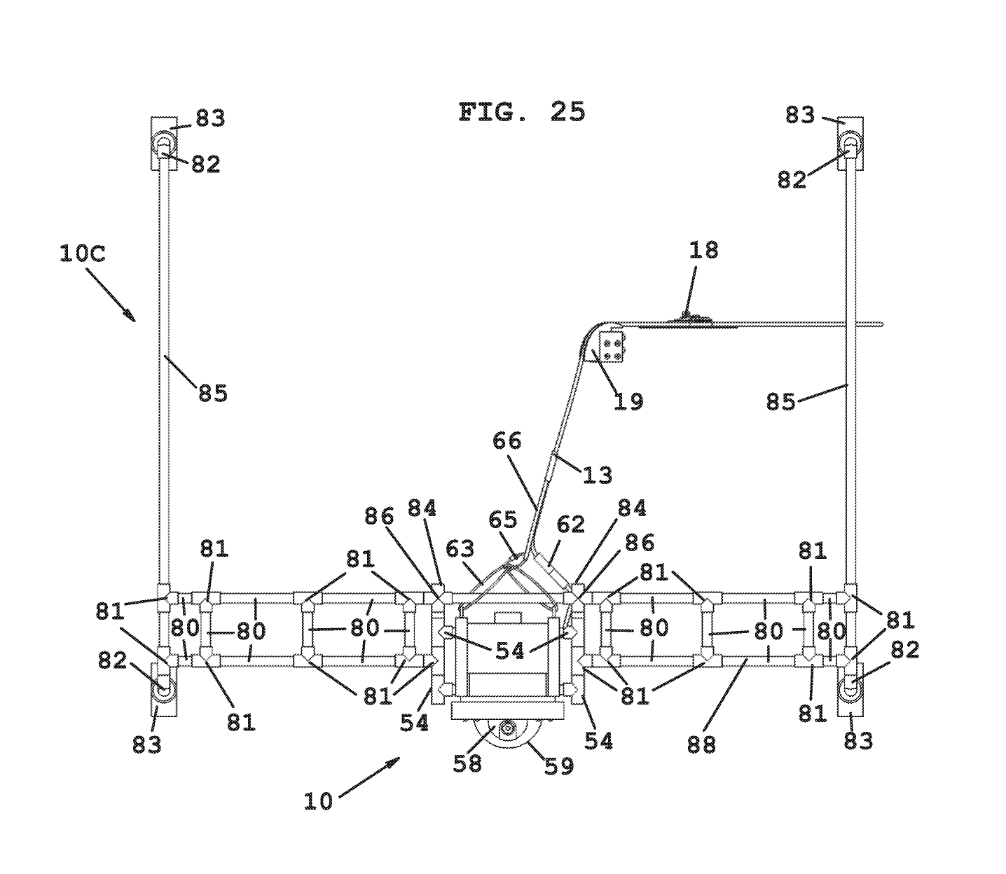

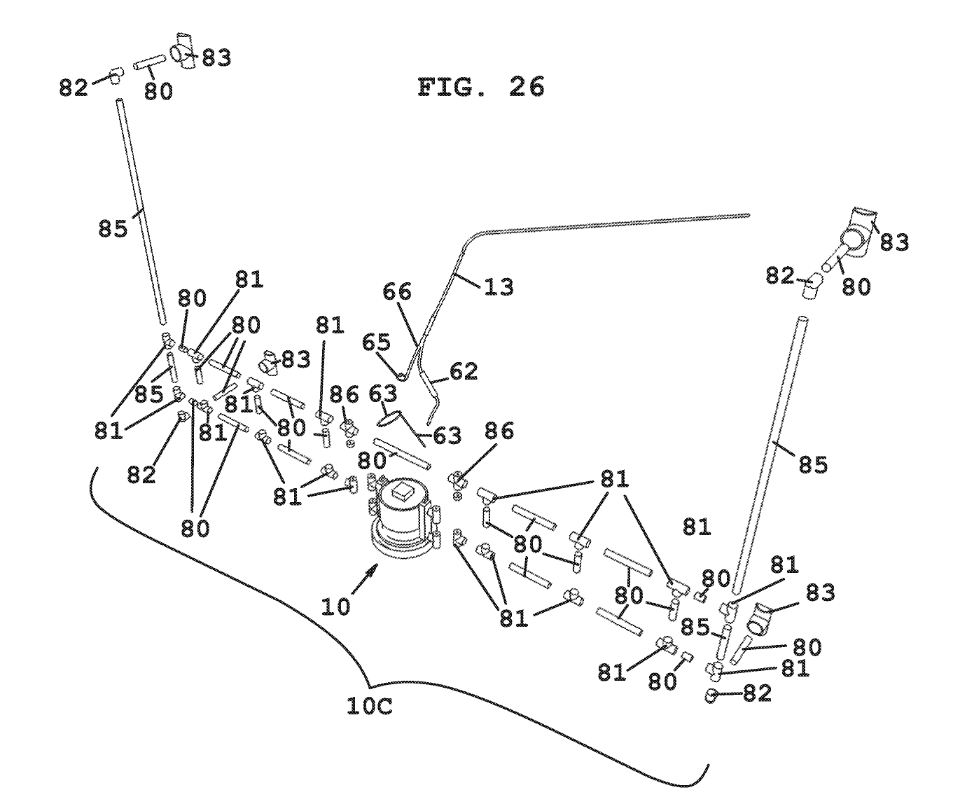

FIG. 23 is a pictorial view of a the mooring assembly 10c with a pan-tilt-zoom underwater camera pod 10 used in the first embodiment. FIG. 24 is a schematic side elevation view of the mooring assembly 10c with a pan-tilt-zoom underwater camera pod 10 used in the first embodiment. FIG. 25 is a schematic front elevation view of the mooring assembly 10c with a pan-tilt-zoom underwater camera pod 10 used in the first embodiment. FIG. 26 is an exploded view of the mooring assembly 10c with a pan-tilt-zoom underwater camera pod 10 used in the first embodiment.

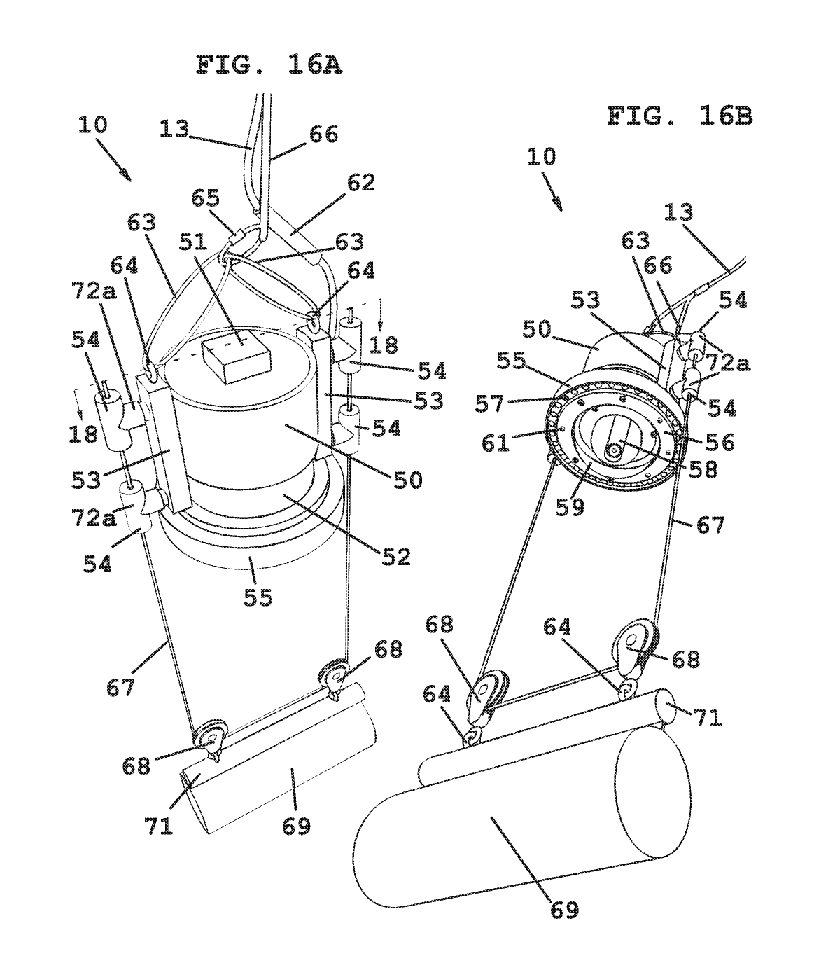

The mooring assembly 10c of the first embodiment may conveniently be constructed using a variety of PVC pipes and fittings. It is understood that the mooring assembly could be manufactured of any other suitable material selected in accordance with good engineering practice. A pair of vertically extending parallel PVC guide rods 85 are horizontally spaced apart and are fixed via stand offs 80 (for example ½″ PVC Pipe) to structural members of the structure 17 built out from the land over water using modified PVC Tees 83 (for example 1 ¼″ PVC Tees). The guide rods 85 of the mooring assembly 10c are fixed to the structure 17 using a fastening system such as bolts or clamps compatible with the design and material of the structure 17 and selected in accordance with good engineering practice. The stand offs 80 are fixed to the guide rods 85 for example with PVC 90′ Ells 82 (for example ½″ PVC 90′ Ells). A horizontal sliding camera support 88 may be constructed for example using a combination of PVC straight pipes 80, PVC Tees 81, and PVC 90′ Ells 82, PVC Cross' 86 (for example all having ½″ internal diameters). The horizontal sliding camera support 88 is fixed to the two vertically extending parallel guide rods 85 using PVC Tees 81 that receive the guide rods 85 through the straight portions of the Tees to facilitate the horizontal sliding camera support 88 sliding vertically up and down the guide rods 85 allowing the camera pod 10 fixed to the horizontal sliding camera support 88 to be lowered into a body of water as shown in FIG. 11 and raised to be above the water as shown in FIG. 12. PVC Tees 54 that are part of the camera assembly are aligned with the vertically oriented portions of PVC Tees 81 and PVC Crosses 86 so that in concert vertically extending passages in the PVC Tees 54 of the camera assembly and PVC Tees 81 and PVC Crosses 86 of the horizontal sliding camera support 88 are aligned like a plano hinge and a suitable pins 84 (see FIG. 25) extend through the aligned passages and secured in a suitable manner to fix the camera pod 10 to the horizontal sliding camera support in a removable manner. The structure and function of the camera pod 10 is described in more detail below, but for now please refer also to FIG. 16 for clarity in understanding the attachment of the tether 13 to the camera pod 10. Stainless steel screw eyes 64 attached to top portions of the camera pod 10. The tether 13 which includes an appropriate number of electrical conductors for conducting control signals and power to the camera and image signals from the camera. To prevent damage to the electrical connections 62 of the tether to the camera when the tether is pulled on to move the horizontal sliding camera support 88 with respect to the guide rods 85 the tether is fixed to a strain relief cable 66 that transmits stress during such pulling. The strain relief cable is provided with a loop that is linked with a pair of strain relief cable retaining rings 63 as best seen in FIG. 16A. A tether guide 19 helps to reduce damage and movement of the tether with respect to an edge of a structure to which the mooring assembly 10c of the first embodiment is mounted. As a tether clamping device 18 is fixed to structure to which the mooring assembly 10c of the first embodiment is mounted to secure the tether from unwanted tampering and is described in detail below with respect to FIGS. 27-30A.

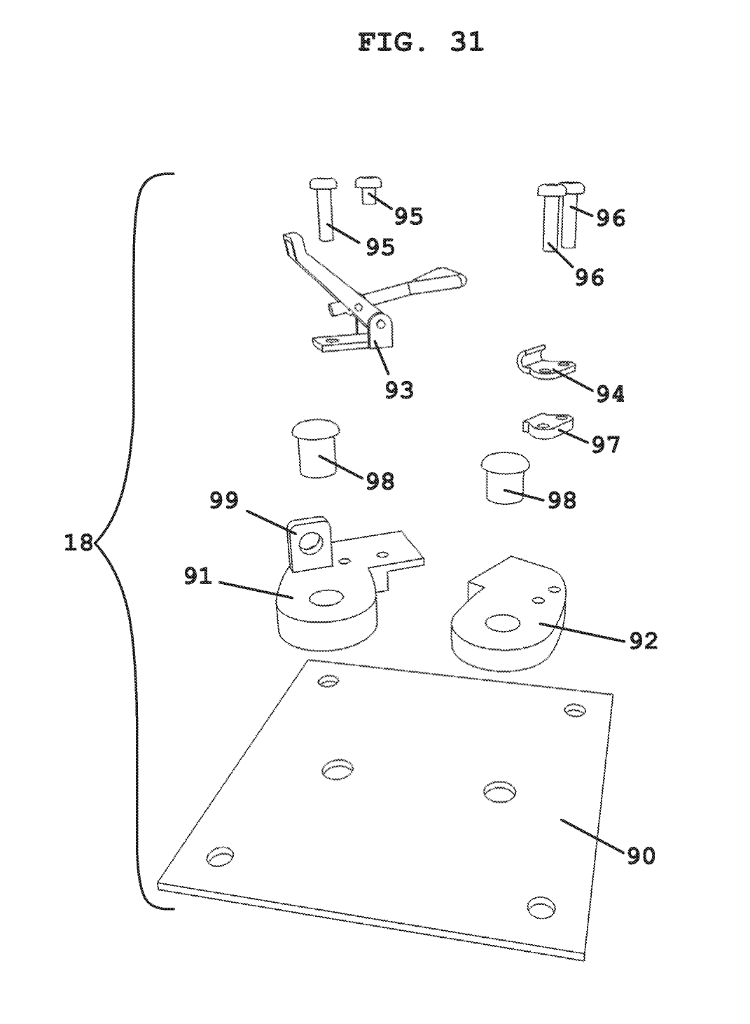

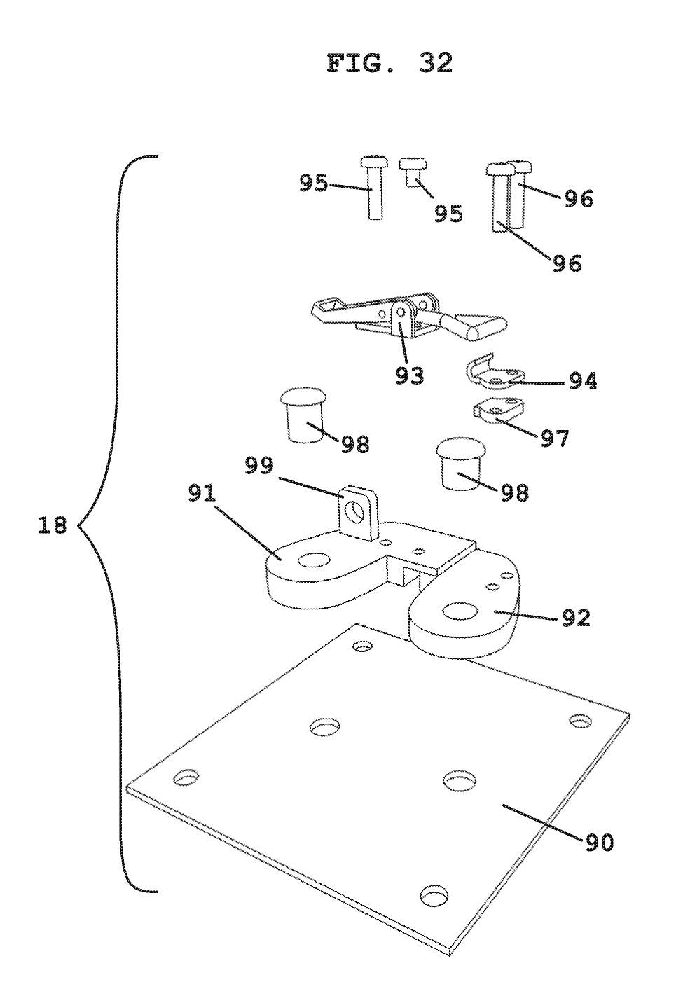

FIGS. 27-30A show an exemplary clamping device 18 with a security feature 93, 99 for use with the system used in the first embodiment for mounting the mooring system to a structure built out from the land over water. FIGS. 31-32 are exploded views of the exemplary clamping device 18 used in the first embodiment. The clamping device 18 is fixed to surface of a structure built out from the land over water as shown for example in FIGS. 7, 8 and 10-13. The method of attaching the clamping device to the structure built out from the land over water is of course dependent upon the material(s) used in the construction of the structure. For instance if the structure is constructed of wood the clamp may be attached to a deck of the structure using threaded fasteners that extend through holes in the mounting plate 90 of clamping device. However it is understood that the clamping device may be attached to a structure built out from the land over water in any appropriate manner selected in accordance with good engineering practices.

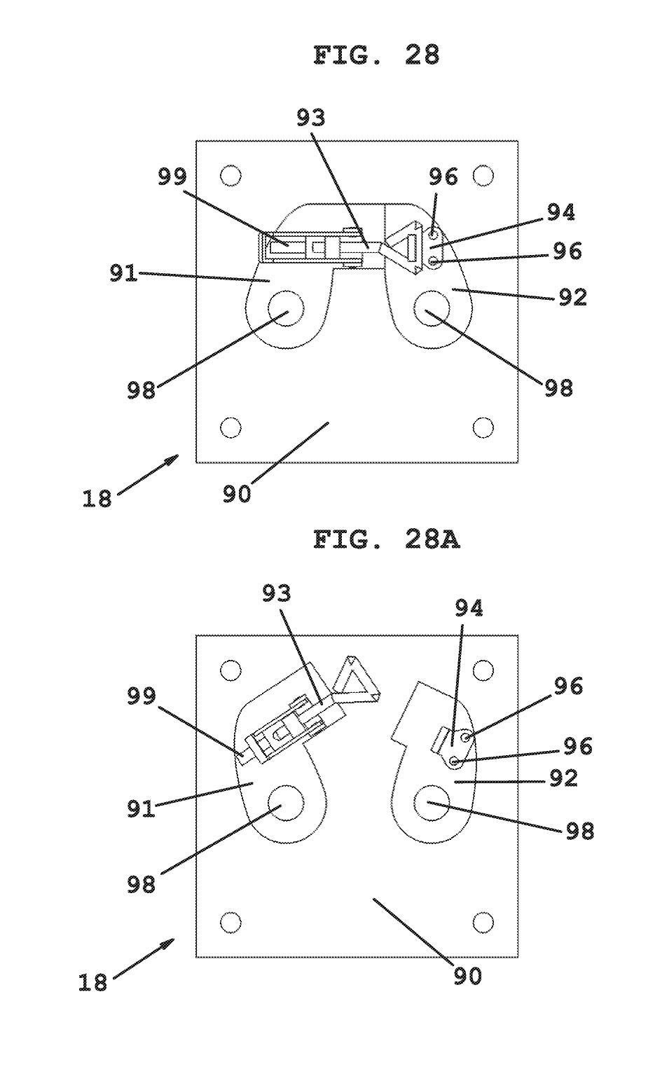

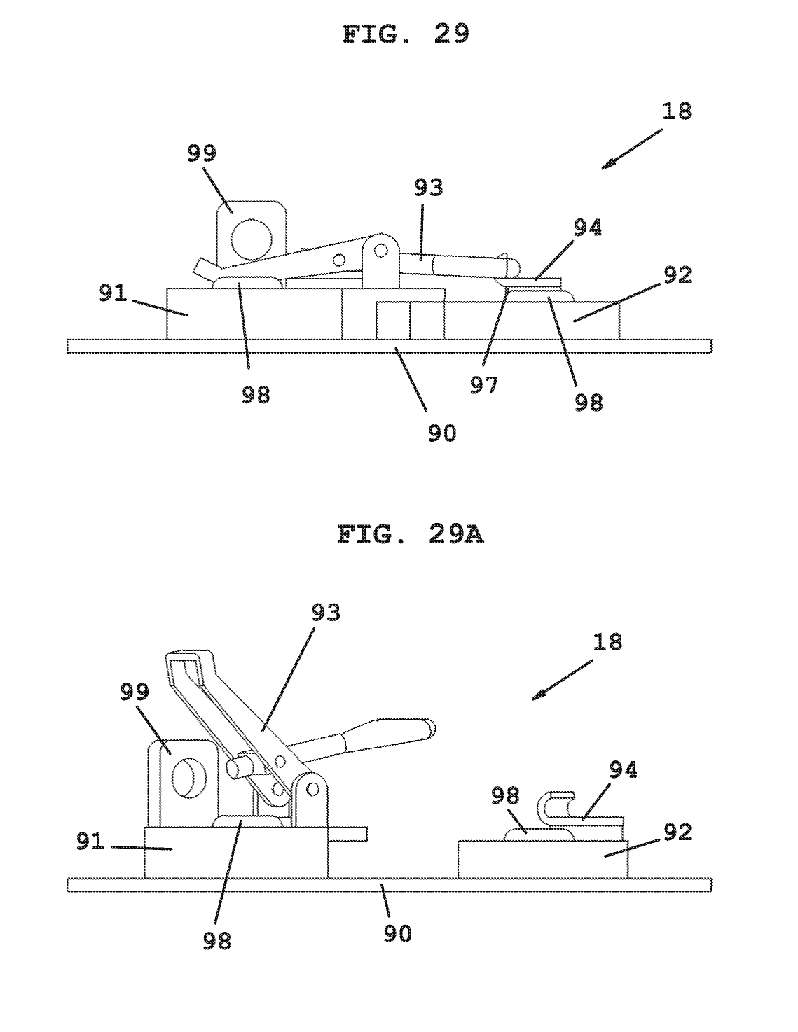

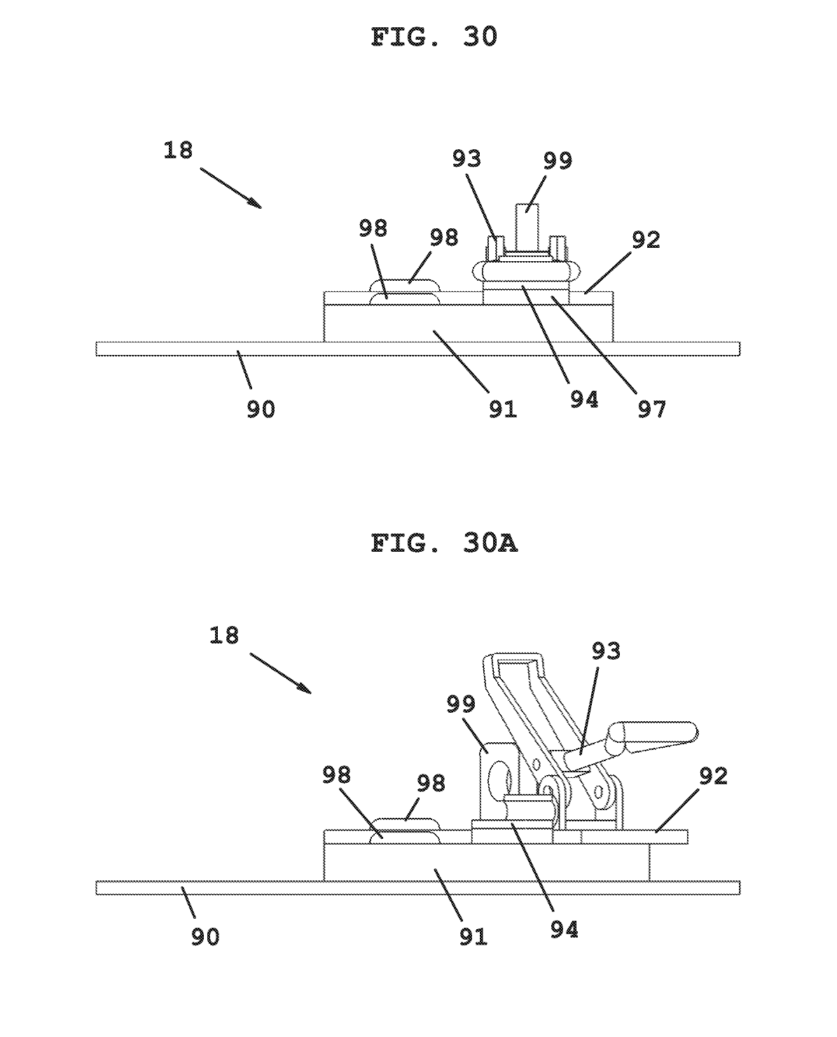

FIG. 27 is a perspective view of a clamping device 18 for the tether in an open configuration. FIG. 28A is a top view of the clamping device 18 in an open configuration. FIG. 29A is a front elevation view of the clamping device 18 with the security feature 93, 99 in an open configuration. FIG. 30A is a right elevation view of the clamping device 18 with the security feature 93, 99 in an open configuration. FIG. 31 is an exploded view of the clamping device 18 with the security feature 93, 99 in an open configuration. FIG. 27A is a perspective view of the clamping device 18 for the tether in a closed configuration. FIG. 28 is a top view of the clamping device 18 in a closed configuration. FIG. 29 is a front elevation view of the clamping device 18 with the security feature 93, 99 in a closed configuration. FIG. 30 is a right elevation view of the clamping device 18 with the security feature 93, 99 in a closed configuration. FIG. 32 is an exploded view of the clamping device 18 with the security feature 93, 99 in an open configuration.

An exemplary clamping device 18 shown in the FIGS. 27-32 has a base plate 90 with a substantially flat configuration. It is understood that the shape of the base plate may be adapted to conform with the shape of a component of a structure built out from the land over water to which the base plate will be attached. The base plate is provided with appropriate through holes to accommodate fasteners used for attaching the base plate to a structure and the attachment of components of the clamping device to the base plate. A first clamping cam 91 is attached to the mounting plate 90 by a clamp pivot pin 98, which allows the first clamping cam to pivot about the clamp pivot pin 98. A second clamping cam 92 is attached to the mounting plate 90 by a clamp pivot pin 98, which allows the second clamping cam to pivot about the clamp pivot pin 98. The first clamping cam is provided with a projection 99 that is oriented substantially perpendicular to the mounting plate 90 when the first clamping cam is attached to the mounting plate. A latch clip 94 is fixed to the second clamping cam 92 with a latch clip spacer 97 disposed between the latch clip 94 and the second clamping cam 92. A pair of latch clip bolts 96 extend through aligned holes in the latch clip 94, latch clip spacer 97 and second clamping cam 92 to secure the latch clip, latch clip spacer and second clamping cam together. A clamp latch 93 is fixed to the first clamping cam by a pair of latch clip bolts 96. The clamp latch 93 has a pair of arms that pivot in a scissor manner. When the two clamping cams are pivoted into a closed configuration, as shown in FIGS. 27A, 28, 29 and 32, a loop at an end of one of the arms mates with the latch clip 94 and a slot in the other arm receives the projection 99. The projection 90 has a through hole that accommodates a shackle of a padlock when the clamping device is in a closed configuration with a tether clamped between the clamping cams 91, 92. The clamping device has two functions: clamping the tether to retain the camera and acting as a security device to impair tampering with the underwater observation system of the first embodiment.

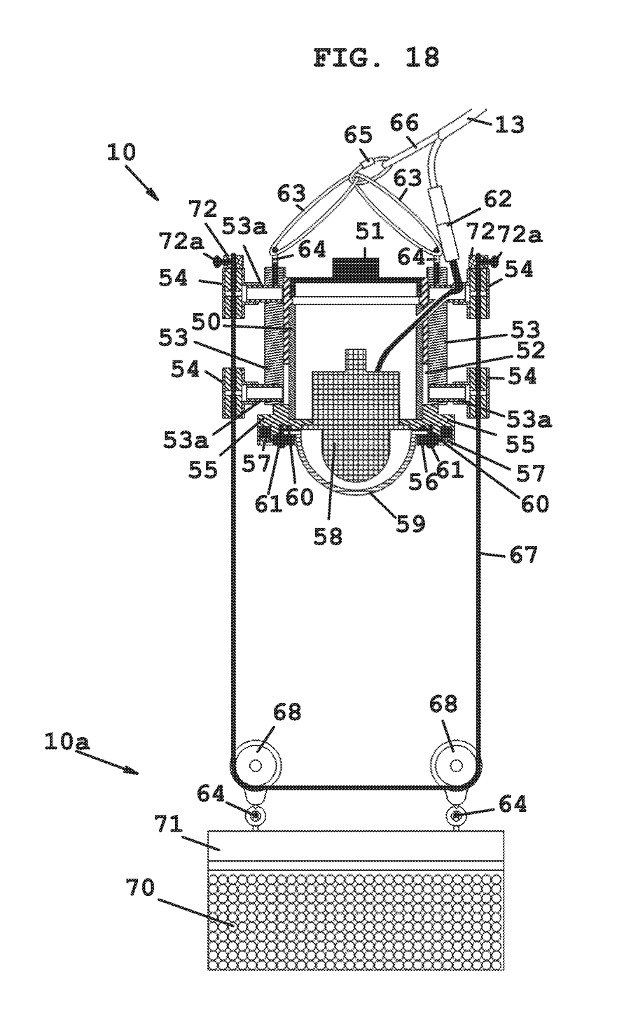

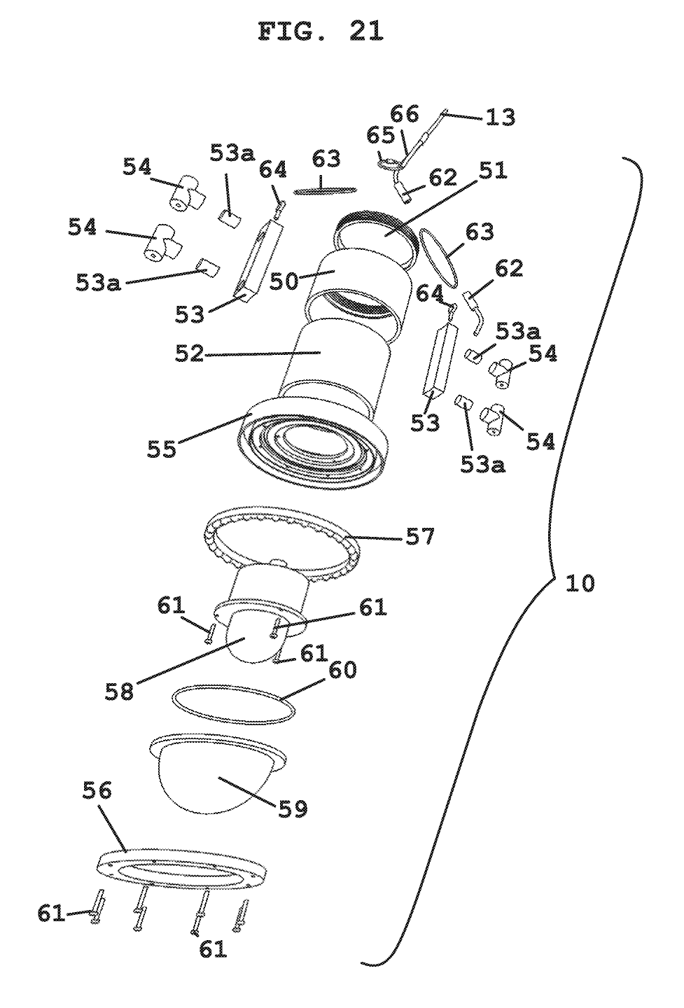

FIG. 21 is an exploded view of a camera pod 10 used with the first, second and third embodiments of the exemplary mooring systems with an underwater camera. The structure of the exemplary camera pod may be made clearer by concurrently referring to FIGS. 16A-20 which present various views of the assembled camera pod, especially FIG. 18 which presents a longitudinal cross section of the assembled camera pod. An exemplary camera pod subassembly comprises a 6″ PVC pipe 52 having one end fixed to a 6″ PVC female threaded clean out 50. An end of the clean out distal from the 6″ PVC pipe is fixed to a 6″ PVC threaded clean out cap 51. An end of the 6″ PVC Pipe 52 distal from the 6″ PVC female threaded clean out 50 is fixed to an LED array housing 55 that receives an LED array 57. A pan/tilt/zoom camera 58 is received partially in the 6″ PVC pipe 52 with a circumferentially extending flange of the pan/tilt/zoom camera adjacent to a portion of the LED array housing 55 and secured to the LED array housing 55 by a plurality of #10 stainless machine screws 61. Underwater pan-tilt-zoom underwater cameras are commercially available, for example a 500 tvl underwater ptz camera 10 zoom 1000 m & 3.8-38 mm lens is currently available for purchase over the internet from Alibaba.com®. A dome O-ring seal 60 is located between the LED array housing 55 and a dome 59 made of PLEXIGLASS®. The dome 59 is provided with a circumferentially extending flange. A toroidal dome seal plate 56 made of PLEXIGLASS® overlies the circumferentially extending flange of the dome 59 and is fixed o the LED array housing 55 by a plurality of #10 stainless machine screws 61.

A pair of depth cable guide rails 53 are fixed in to the exterior of the 6″ PVC pipe 52 in diametrically opposed locations. A stainless steel screw eye 64 is fixed to each of the depth cable guide rails 53 and extends longitudinally with respect to the associated depth cable guide rail 53. Each of the depth cable guide rails 53 is provided with a pair of bores that each receive a cable guide tee mount post 53a, oriented such that each of the cable guide tee mount posts 53a is oriented at least substantially perpendicular to a longitudinal axis of the 6″ PVC pipe 52. An adjustable depth cable guide tee 54 is fixed to each of the cable guide tee mount post 53a with the cross portions of the tees oriented at least substantially perpendicular to a longitudinal axis of the 6″ PVC pipe 52. Put another way, the lumens of the cross portions of the guide tees 54 on each side of the 6″ PVC pipe 52 are aligned to have a common longitudinal axis. As shown in FIG. 25 and described above in paragraph [0047] the guide tees 54 are used in the attachment of a camera pod to the mooring assembly 10c in a first embodiment of the present invention. The function of the guide tees 54 in the second and third embodiments of the invention are described in detail below.

A tether 13 includes an appropriate number of electrical conductor for conducting control signals and power to the camera and image signals from the camera 58. As shown best in FIG. 18 in this exemplary camera pod a short length of conductive cable 62 with a suitable connection fitting extends from the camera 58 to the exterior of the camera pod 10. The tether is plugged into the connection fitting of the short length of conductive cable 62 in a waterproof manner. This feature allows the tether 13 to be separated from the camera pod prior to assembly with the camera pod and to facilitate maintenance of the camera pod. To prevent damage to the electrical connections of the tether to the camera when the tether is pulled on to move the camera pod the tether is fixed to a strain relief cable 66 that transmits stress during such pulling. The strain relief cable is provided with a loop that is linked with a pair of strain relief cable retaining rings 63 as best seen in FIGS. 16A and 18.

In the exemplary camera pod shown in the drawings and described herein the housing of the camera pod is constructed of readily available PVC pipes and fittings that may be fixed to one another using commercially available adhesives and threaded joints. However it is understood that any suitable material(s) may be used to fabricate a housing of a camera pod and that the dimensions and geometry of the camera pod may be varied to work with any suitable pan-tilt-zoom underwater camera without departing from the scope of the claimed invention.

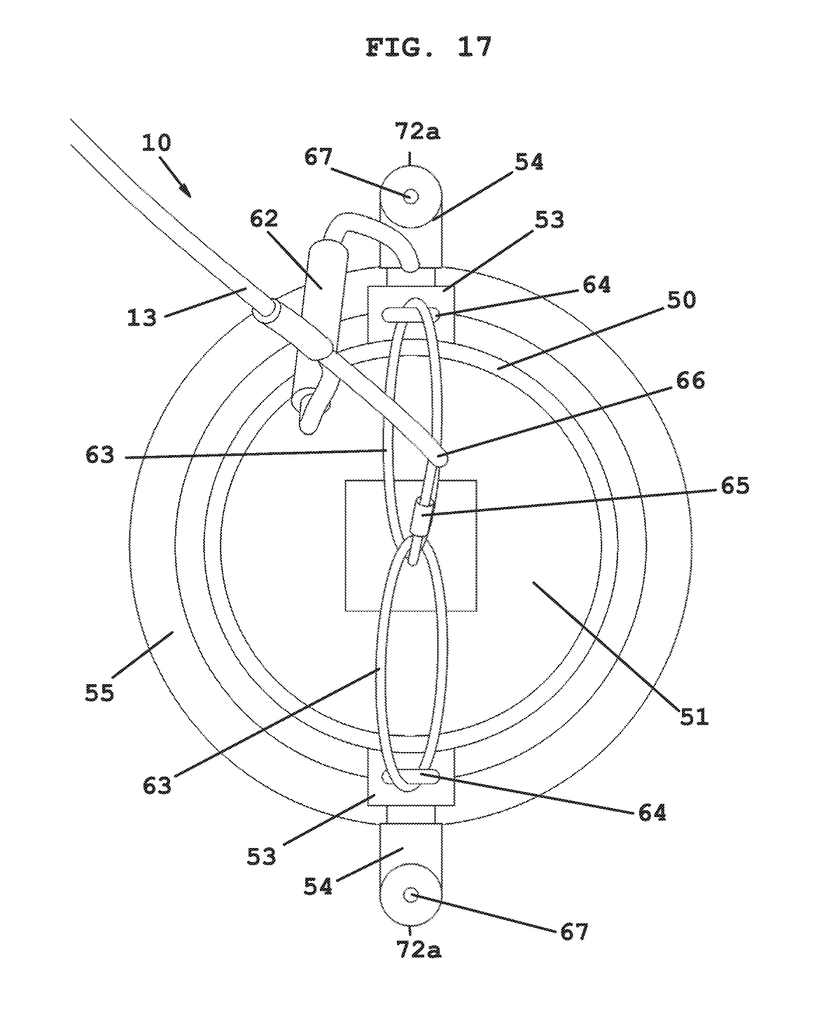

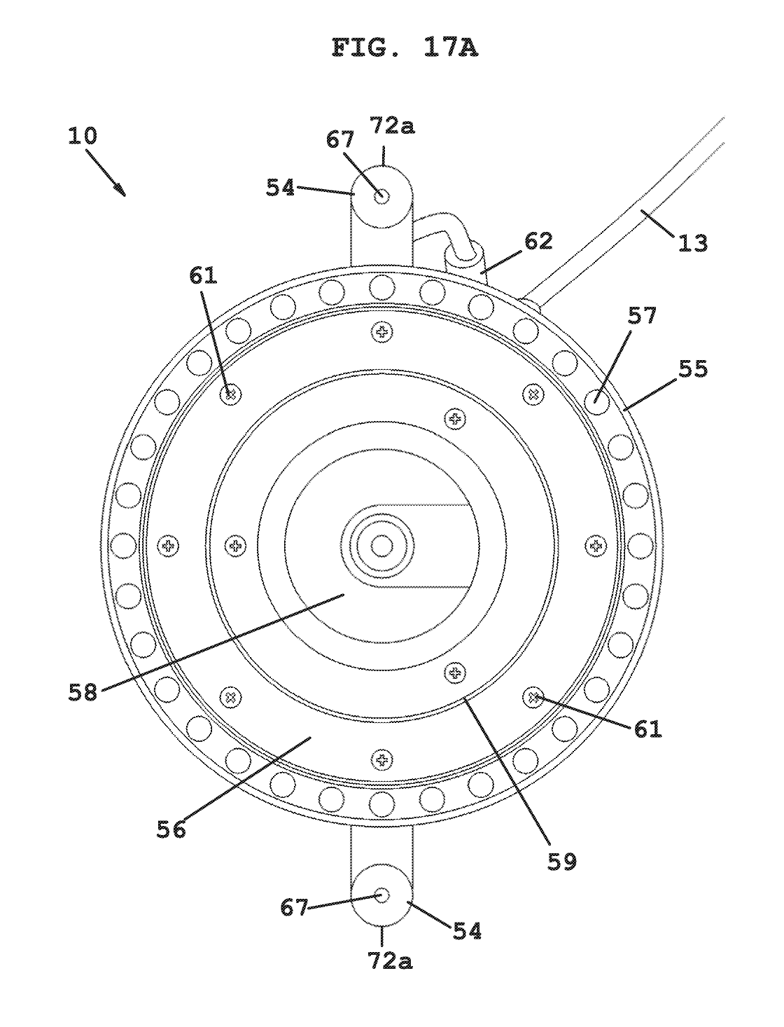

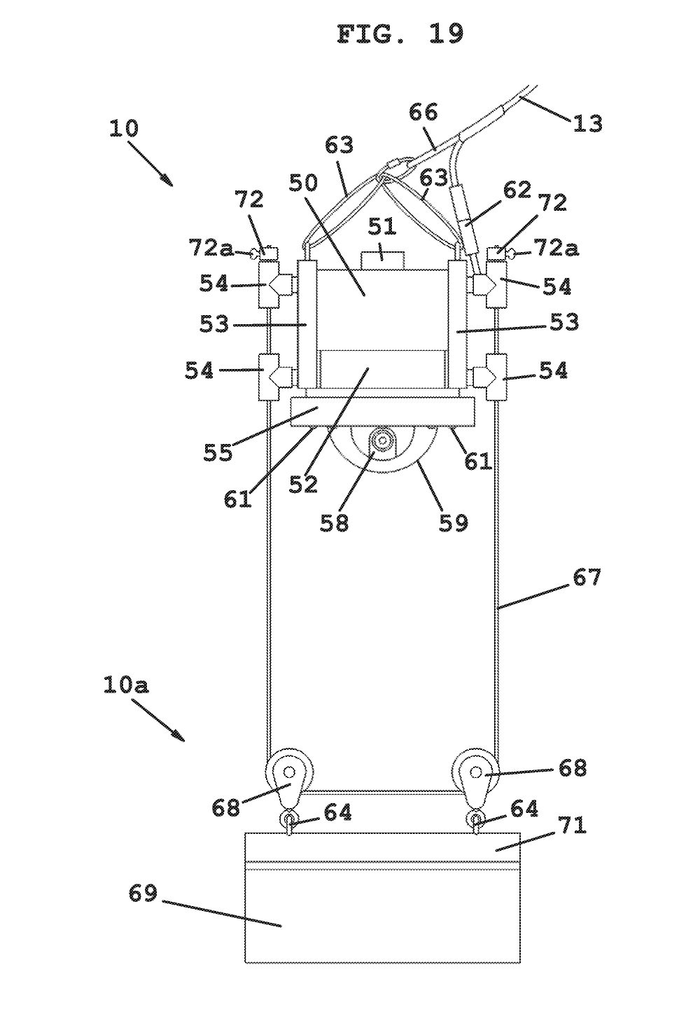

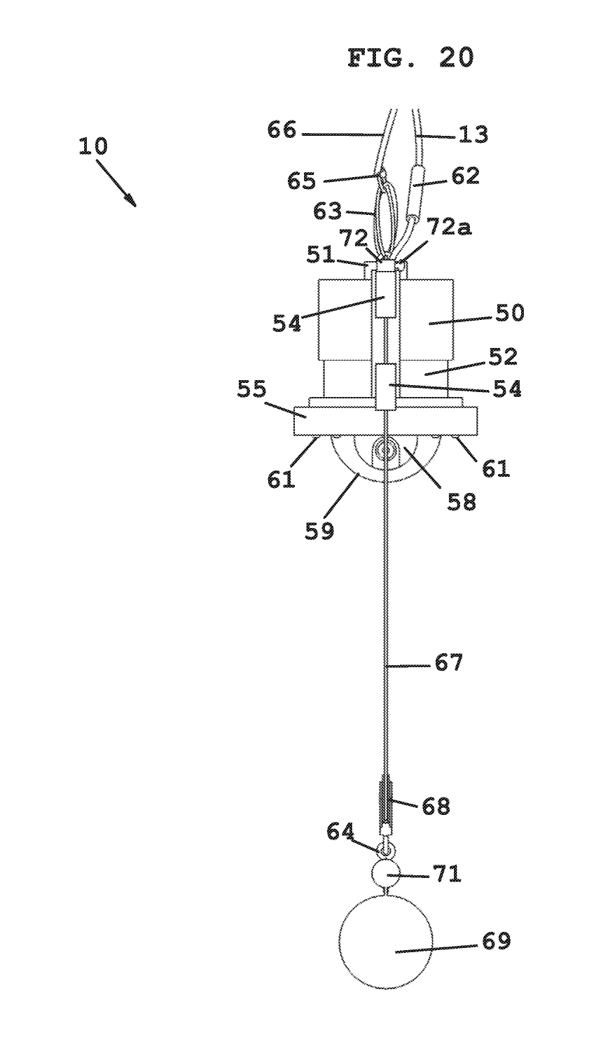

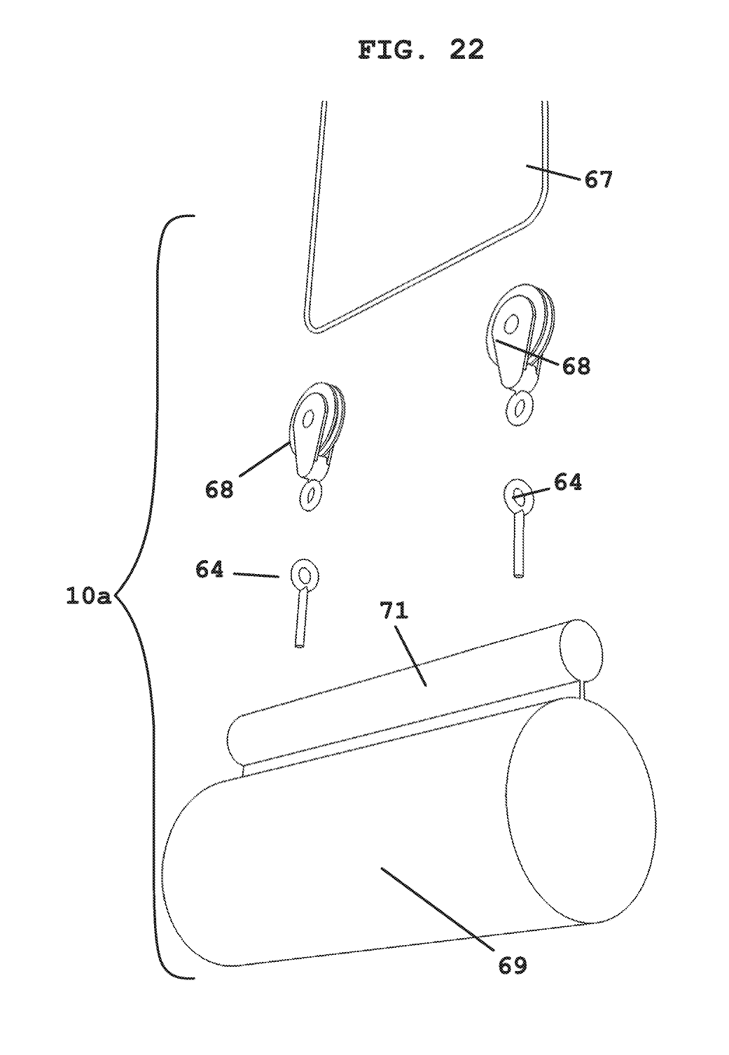

FIGS. 16A-17A are pictorial representations of a second embodiment of an exemplary mooring system with an underwater camera according to the present invention. FIG. 16A is a top perspective view of the mooring system with an underwater camera. FIG. 16B is a bottom perspective view of the mooring system with an underwater camera. FIG. 17 is a top view of the mooring system with an underwater camera. FIG. 17A is a bottom view of the mooring system with an underwater camera. FIG. 18 is a section view of the second embodiment taken at line 18-18 of FIG. 16A. FIG. 19 is a front elevation view of the second embodiment. FIG. 20 is a side elevation view of the second embodiment. FIG. 22 is an exploded view of a mooring subassembly of the second embodiment.

In the second embodiment the camera pod 10 is mated with a mooring system 10a. In the exemplary mooring system 10a includes a ballast bag 69, made for example of a suitable mesh fabric such as TEXTILENE®. Ballast comprising for example gravel of the type commonly used in aquariums, however any suitable material may be used as ballast in an amount selected in accordance with good engineering practices. The ballast bag 69 is fixed to a pulley separator rod 71 by any suitable means such as folding the ballast bag around the rod and sewing the bag to itself. The pulley separator rod 71 may comprise any suitable material such as a solid PVC rod. A pair of stainless steel screw eyes 64 are fixed to the pulley separator rod 71 by any suitable means such as screwing the screw eyes into the solid PVC rod. A pulley 68 is linked to each of the stainless steel screw eyes 64. A stainless steel depth cable 67 extends through the both of the adjustable depth cable guide tees 54 on opposing sides of the housing of the camera pod. The stainless steel depth cable 67 is guided by both of the pulleys 68 to form a loop as best shown in the FIGS. 18 and 19. The stainless steel depth cable 67 is secured to the camera pod in the configuration shown in the drawings using cable retainers 72 that are adjacent adjustable depth cable guide tees 54 as best shown in the FIGS. 18 and 19. The cable retainers 72 are tightened around the stainless steel depth cable 67with thumb screw s 72a as best shown in the FIGS. 18 and 19. It is understood that the second embodiment described herein is only exemplary and that other suitable materials and hardware selected in accordance with good engineering practice may be used in the practice of the invention disclosed and claimed herein.

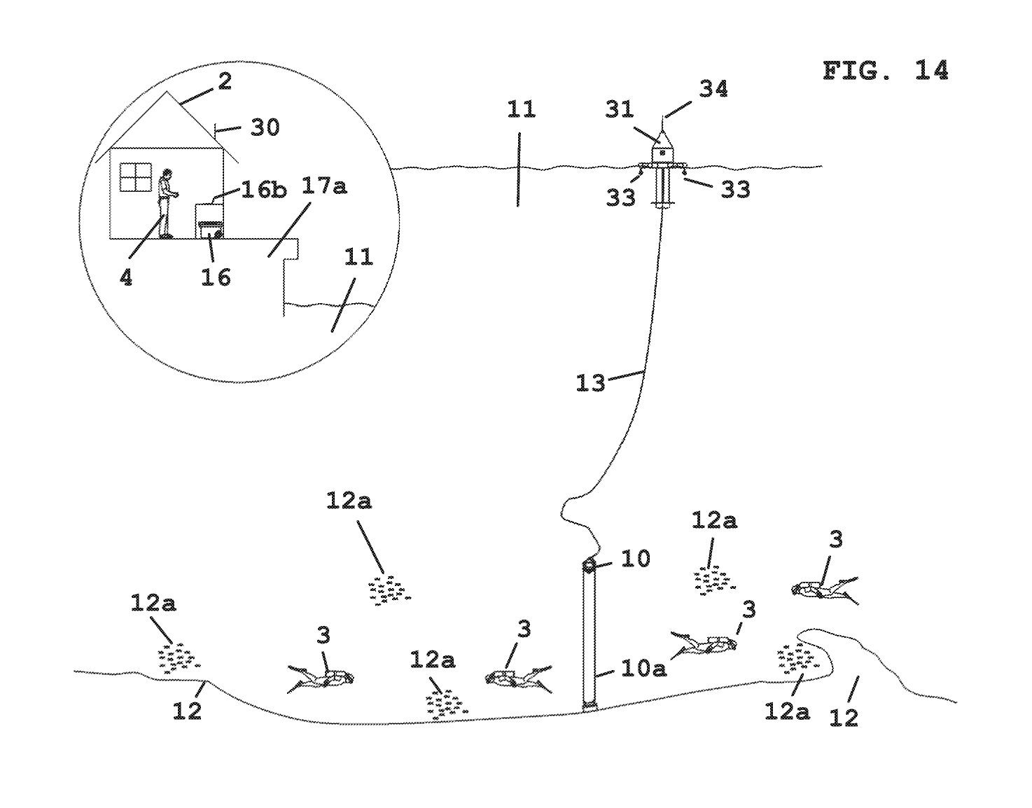

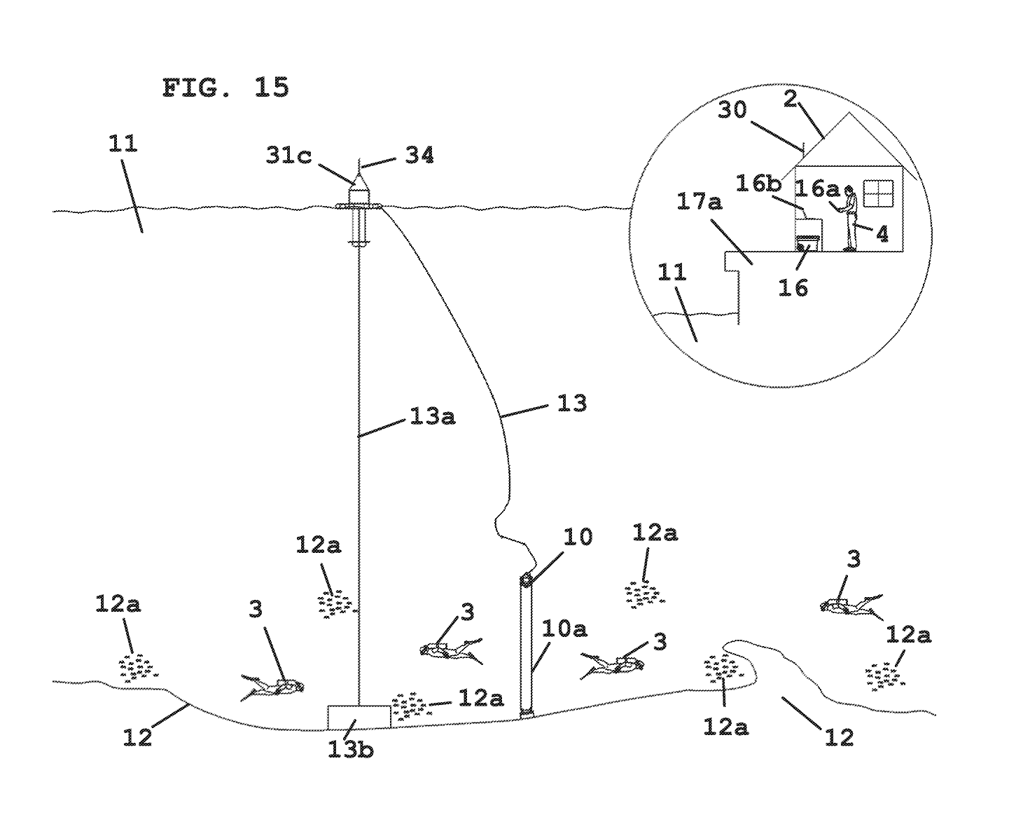

The deployment from a floating vessel and advantages of the mooring system 10a of the second embodiment have been described above with reference to FIGS. 5-6. The deployment from a structure built out from the land over water and advantages of the mooring system 10a of the second embodiment have been described above with reference to FIG. 8. The deployment from a floating buoy and advantages of the mooring system 10a of the second embodiment are described below with reference to FIGS. 14-15.

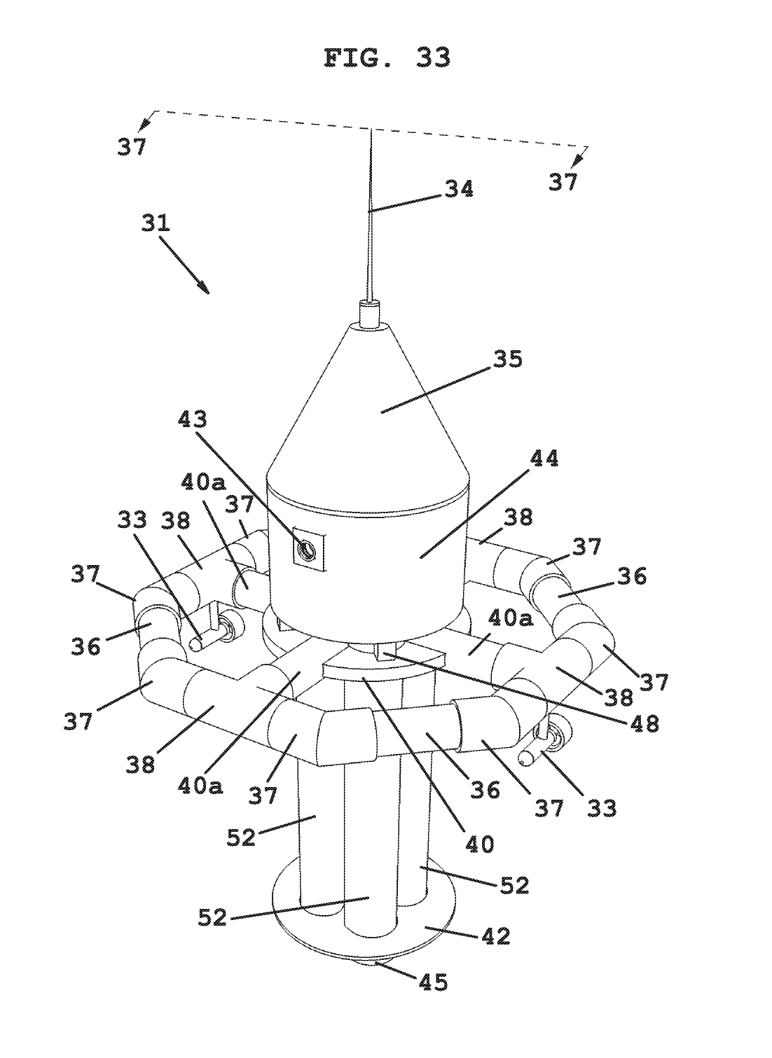

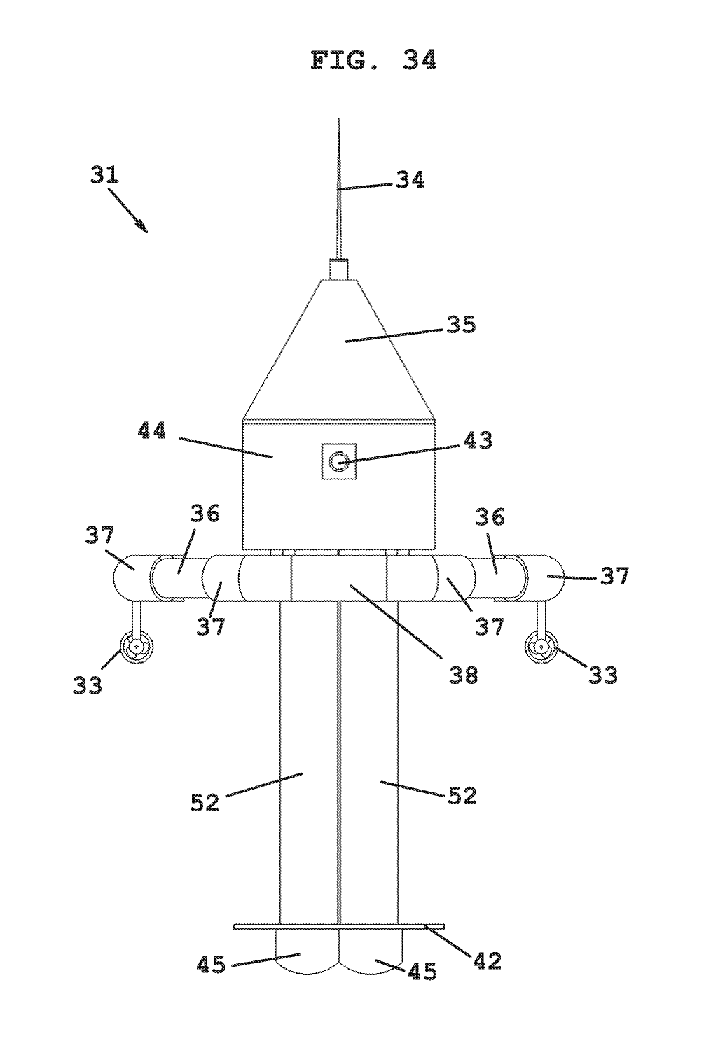

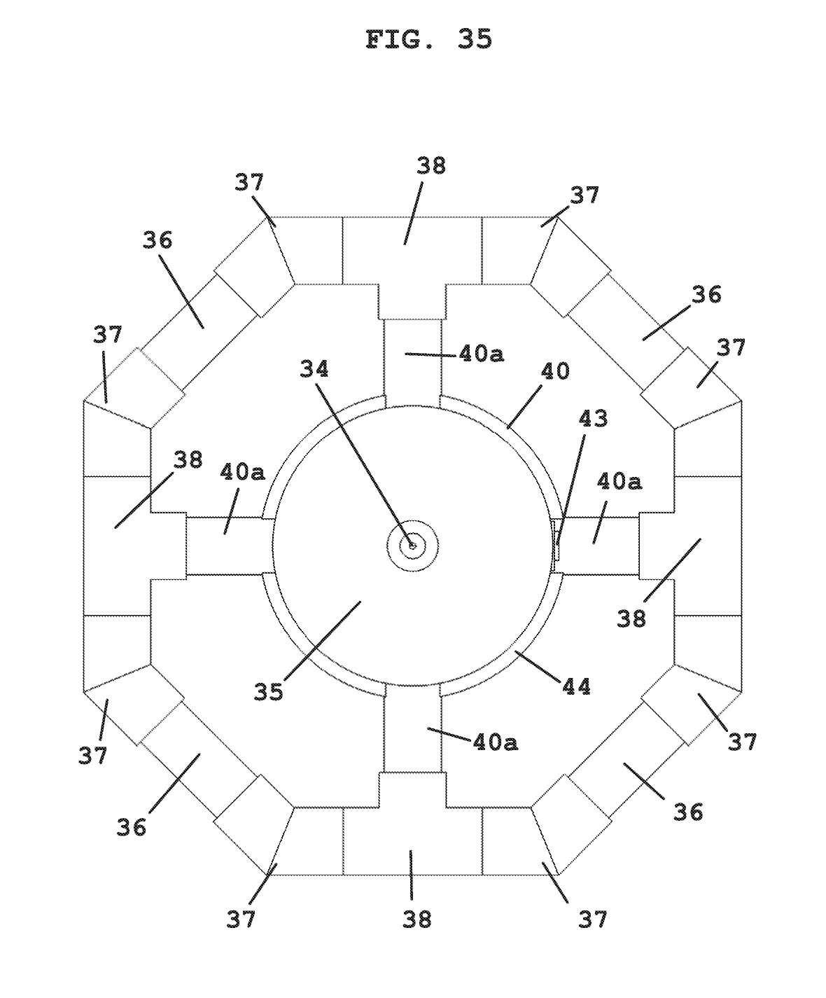

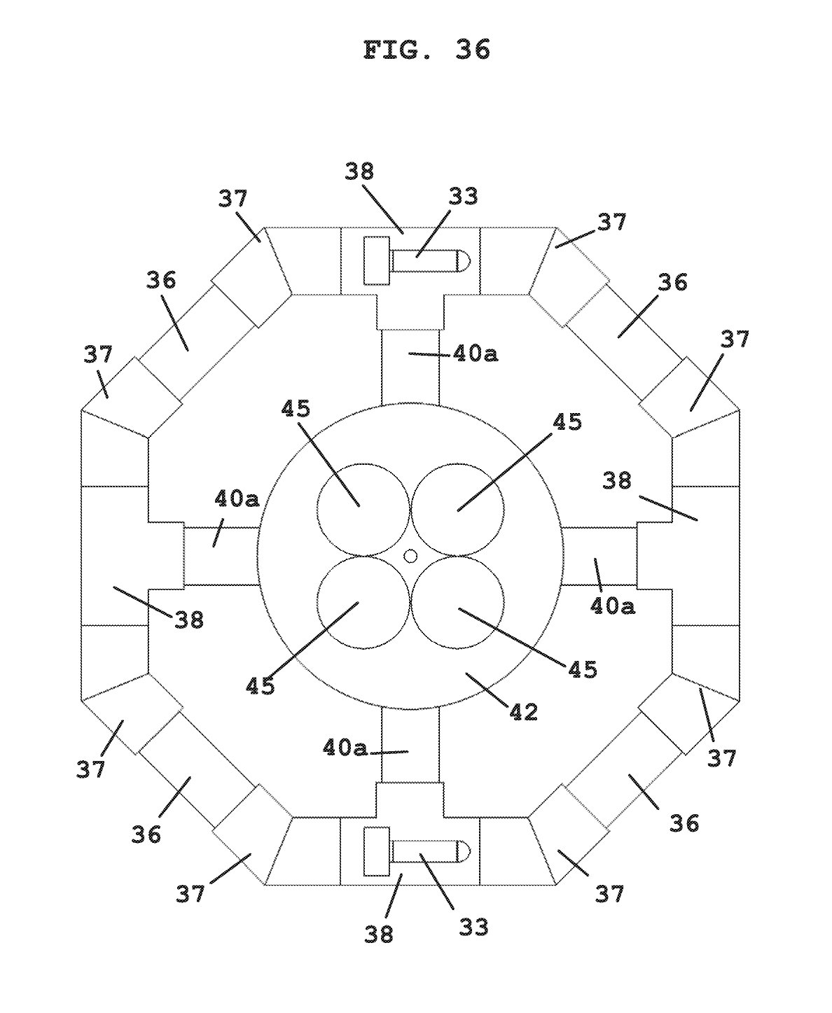

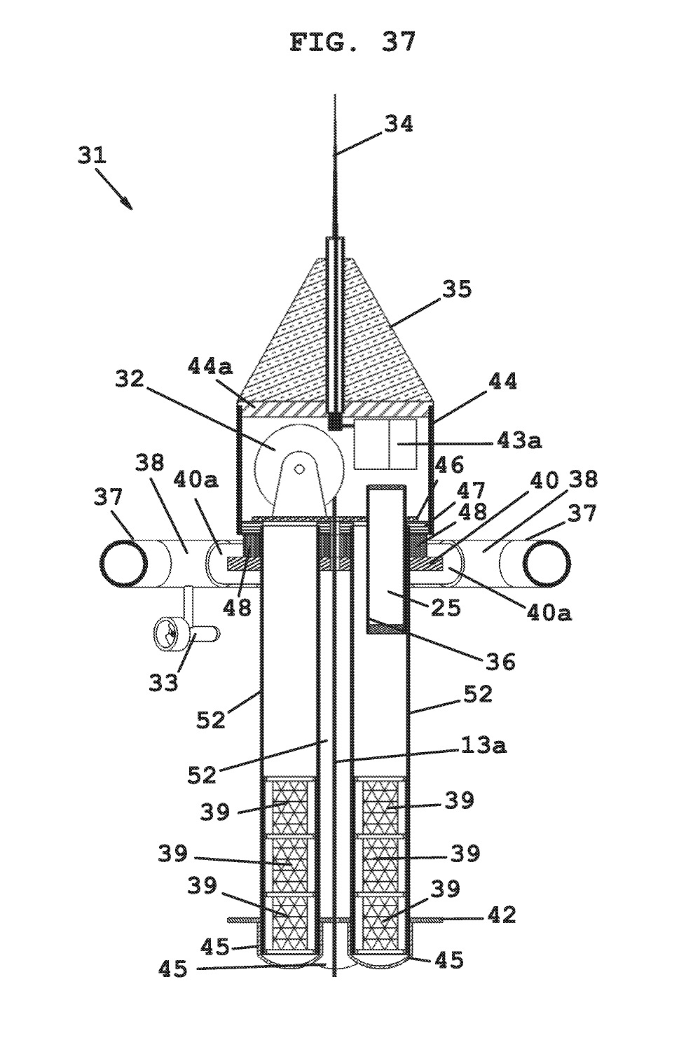

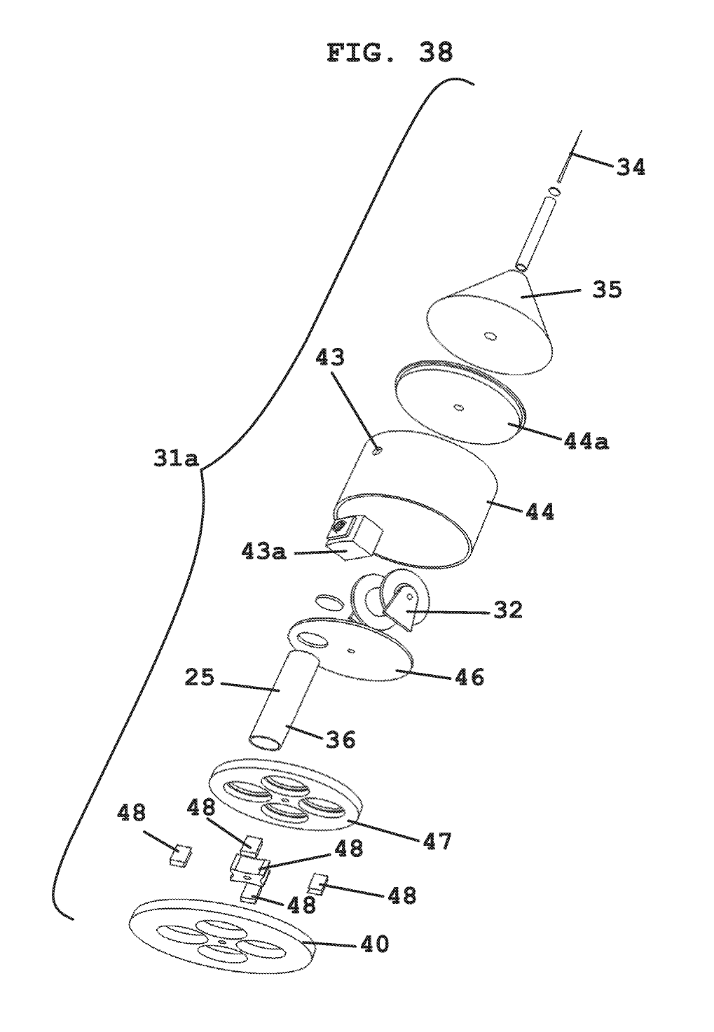

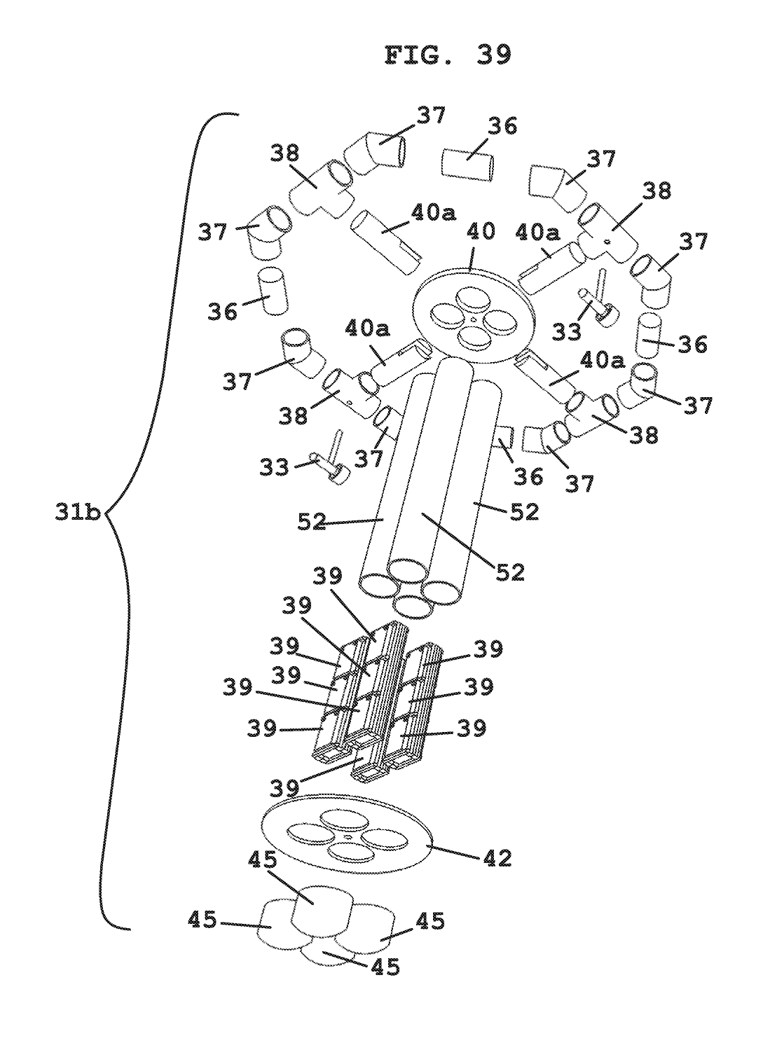

FIGS. 14-15 show a third embodiment of an exemplary mooring system for an underwater camera according to the present invention deployed using a buoy 31. FIG. 33 is a perspective view of an exemplary buoy 31 usable in the third embodiment. FIG. 34 is a front elevation view of the exemplary buoy 31. FIG. 35 is a top view of the exemplary buoy 31. FIG. 36 is a bottom view of the exemplary buoy 31. FIG. 37 is a section view of the exemplary buoy 31 taken at line 37-37 of FIG. 33. FIG. 38 is an exploded view of an upper subassembly 31a of the exemplary buoy 31. FIG. 39 is an exploded view of a lower subassembly 31b of the exemplary buoy 31.

An exemplary buoy 31 usable in a third embodiment with the mooring system 10a and camera pod 10 described above has an upper subassembly 31a and a lower subassembly 31b with central connection hub 40 common to both subassemblies. As shown best in FIGS. 37 and 38 in the upper subassembly 31 a battery pack tube connection plate spacers 48 are located between and adjacent the central connection hub 40 and a battery pack tube connection plate 47. An electronics package 25 is located in a 4″ PVC pipe 36 that extends through the through holes in a battery pack tube cover plate 46 and aligned through holes in the battery pack tube connection plate 47 and the central connection hub 40. A camera pod tether take up reel 32 is fixed to a side of the battery pack tube cover plate 46 that is distal from the battery pack tube connection plate 47. A tubular electronics housing 44 is fixed to a circumferential surface of the battery pack tube connection plate 47. An electronics housing top plate 44a is fixed to a top edge of the tubular electronics housing 44. A camera in a housing 43a is suspended from the electronics housing top plate 44a and aligned with a camera port 43 in the tubular electronics housing 44. As shown in FIG. 37 the camera is in circuit communication with an antenna 34 for sending images taken above the surface of a body of water. A rotating photovoltaic cone array 35 is fixed to a side of the electronics housing top plate 44a distal from the battery pack tube cover plate 46. An antenna 34 for transmitting image signals from a camera pod 10 and receiving command signals for the camera pod from a remote base station 16 (see FIGS. 14-15) is fixed to the rotating photovoltaic cone array 35.

As shown best in FIGS. 37 and 39 in the lower subassembly 31b of the exemplary buoy 31 the central connection hub 40 is fixed to a plurality of central connection hub adapters 40a using slots in the central connection hub adapters. Ends of the central connection hub adapters 40a distal from the central connection hub 40 are fixed to the base portions of 4″ PVC tees 38. Each end of the crosses of the 4″ PVC tees 38 are fixed to a 4″ PVC 45′ elbow 37. Ends of the 4″ PVC 45′ elbows 37 are fixed to 4″ PVC pipe 36. The result is a stabilizing octagonal structure best seen in FIG. 5 that is a top view of the assembled buoy. A thruster 33 is mounted to one of the 4″ PVC tees 38 (see FIG. 36) for use in altering the orientation and location of the buoy 31. Four lengths of 6″ PVC pipe 52 extend through aligned through holes of the central connection hub 40 and battery pack tube connection plate 47 and are fixed thereto to attach the upper subassembly 31a to the lower subassembly 31b. The electronics package 25 is disposed partially within one of the lengths of 6″ PVC pipe 52 as best shown in FIG. 37. A plurality of 12 volt batteries 39 are located inside each of the lengths of 6″ PVC pipe 52. The 12 volt batteries provide power to, for example, the thruster 33, the electronics package 25 and via the tether 13 to the pan-tilt-zoom camera in the camera pod 10. A lower central connection hub 42 has through holes that receive the lengths of 6″ PVC pipe 52 and is secured to the lengths of 6″ PVC pipe 52 by 6″ PVC pipe caps 45.

The buoy 31 may be free floating with thrusters 33 as shown in FIG. 14 or anchored in place using an anchor line 13a and anchor 13b without thrusters as shown in FIG. 15. In either case a tether 13 extends between the buoy 31 and the camera pod 10 to transmit power and command signals to the pan-tilt-zoom camera in the camera pod 10 and image signals from the pan-tilt-zoom camera in the camera pod. With reference to FIGS. 15-16 when the buoy and imaging system are deployed on and in a body of water 11 the mooring structure 10a retains the pan-tilt-zoom underwater camera pod 10 at a substantially constant distance from the floor 12 of the body of water. Accordingly a person 4 located on land 17a either outdoors or in a building 2 is able to view at least substantially stable images captured by the pan-tilt-zoom underwater camera in the camera pod 10 transmitted via an antenna 34 of the buoy to a land based antenna 30 to a base station 16 and processed by a laptop PC 16b (or a desktop PC) and viewed on a screen of a of the laptop or a monitor associated with a desktop PC. In FIGS. 14 and 15 a land based person 4 uses a controller 16a (Joystick, Joypad, Keyboard, Flightstick) in conjunction with a laptop PC 16b and appropriate software to send and receive control signals, data, video and sound information between the base station 16 and the buoy 31, 31c to a the pan-tilt-zoom underwater camera in the camera pod 10. Examples of typical objects that may be seen in the body of water 11 near the floor 12 are fish 12a and divers 3

While the invention has been described with reference to certain exemplary embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A device for viewing images from under a surface of a body of water comprising:
(a) a camera pod comprising a housing containing a pan-tilt-zoom underwater camera;
(b) a mooring structure fixed to the camera pod for maintaining the camera pod at a substantially constant distance from a floor of the body of water;
(c) a tether that conducts control signals sent from a base station located above the surface of the body of water a to the pan-tilt-zoom underwater camera and image signals from the pan-tilt-zoom underwater camera to the base station.

2. The device according to claim 1 wherein the mooring structure is mounted on a structure built out from land over the body of water, the mooring structure comprising a pair of vertically extending parallel guide rods fixed to the structure, a horizontally extending camera support that is fixed to and slides vertically on the parallel guide rods, the camera pod being fixed to the horizontally extending camera support.

3. The device according to claim 2 further comprising a tether clamping device located intermediate of the camera pod and the base station that can be locked to secure the tether from unwanted tampering.

4. The device according to claim 1 wherein the mooring structure comprises a ballast that spaced apart from the camera pod and is fixed to the camera pod by a cable.

5. The device according to claim 4 wherein the ballast is located in a ballast bag that is fixed to a pulley separator rod that is fixed to a pair of pulleys, the cable is guided by both of the pulleys to form a loop, and the cable has two ends with the end of the cable secured to the camera pod at diametrically opposed locations.

6. The device according to claim 5 wherein the tether extends from the camera pod to a buoy floating on the surface of the body of water and the buoy communicates with the base station wirelessly.

7. The device according to claim 6 wherein the buoy comprises a source of electrical power and the tether conducts electrical power from the buoy to the pan-tilt-zoom underwater camera.

8. The device according to claim 5 wherein the base station is located on a vessel on the surface of the body of water.

9. The device according to claim 5 wherein the base station is located on land.

10. The device according to claim 5 wherein the base station is located on a structure built out from land over the body of water.

11. A device for viewing images from under a surface of a body of water comprising:
(a) a camera pod comprising a housing containing a pan-tilt-zoom underwater camera, the housing of the camera pod having diametrically opposed cable guides attached to an outer surface if the housing;
(b) a mooring structure fixed to the camera pod for maintaining the camera pod at a substantially constant distance from a floor of the body of water, the mooring structure comprises a ballast that spaced apart from the camera pod and is fixed to the camera pod by a cable having a pair of ends with one of the ends of the cable extending through each of the cable guides and secured to the camera pod housing via the cable guides;
(c) a tether that conducts control signals sent from a base station located above the surface of the body of water a to the pan-tilt-zoom underwater camera and image signals from the pan-tilt-zoom underwater camera to the base station.

12. The device according to claim 11 wherein the ballast is located in a ballast bag that is fixed to a pulley separator rod that is fixed to a pair of pulleys, the cable is guided by both of the pulleys to form a loop.

13. The device according to claim 12 wherein the tether extends from the camera pod to a buoy floating on the surface of the body of water and the buoy communicates with the base station wirelessly.

14. The device according to claim 13 wherein the buoy comprises a source of electrical power and the tether conducts electrical power from the buoy to the pan-tilt-zoom underwater camera.

15. The device according to claim 12 wherein the base station is located on a vessel on the surface of the body of water.

16. The device according to claim 12 wherein the base station is located on land.

17. The device according to claim 12 wherein the base station is located on a structure built out from land over the body of water.

18. The device according to claim 11 wherein the tether conducts image signals to and control signals from an antenna that communicates wirelessly with the base station.

18. The device according to claim 2 wherein the tether conducts image signals to and control signals from an antenna that communicates wirelessly with the base station.
